(19) United States
(12) Patent Application Publication
(10) Pub. No.: US 2015/0269676 A1
(43) Pub. Date: Sep. 24, 2015

(54) METHODS AND SYSTEMS FOR CREATING A CREDIT VOLATILITY INDEX AND TRADING DERIVATIVE PRODUCTS BASED THEREON

(71) Applicant: Applied Academics LLC, New York, NY (US)

(72) Inventors: Antonio Mele, Cimo (CH); Yoshiki Obayashi, New York, NY (US)

(21) Appl. No.: 14/722,994

(22) Filed: May 27, 2015

Related U.S. Application Data
(63) Continuation of application No. 13/841,653, filed on Mar. 15, 2013, now abandoned.
(60) Provisional application No. 61/677,755, filed on Jul. 31, 2012.

(51) Int. Cl. G06Q 40/04

(52) U.S. Cl. CPC G06Q 40/04

(57) ABSTRACT

A computer system for calculating a credit volatility index comprising memory configured to store at least one program; and at least one processor communicatively coupled to the memory, in which the at least one program, when executed by the at least one processor, causes the at least one processor to receive data regarding options on credit default swap index derivatives; calculate, using the data regarding options on credit default swap index derivatives, the credit volatility index; and transmit data regarding the credit volatility index.

### FIELD OF THE DISCLOSURE

The present disclosure relates to fixed income derivative investment markets.

### BACKGROUND

A derivative is a financial instrument whose value depends at least in part on the value and/or characteristic(s) of another security, known as an underlying asset. Examples of underlying assets include, but are not limited to: interest rate financial instruments (e.g., bonds and bond futures), credit financial instruments (e.g. corporate bonds, credit default swaps, and credit default swap indexes), commodities, securities, electronically traded funds, and indices. Two exemplary and well-known derivatives are options and futures contracts.

Derivatives, such as options and futures contracts, may be traded over-the-counter and/or on other trading platforms, such as organized exchanges (e.g., the Chicago Board Options Exchange, Incorporated (“CBOE”)). In over-the-counter transactions the individual parties to a transaction are able to customize each transaction to meet each party's individual needs. With trading platform or exchange traded derivatives, buy and sell orders for standardized derivative contracts are submitted to an exchange where they are matched and executed. Generally, modern trading exchanges have exchange specific computer systems that allow for the electronic submission of orders via electronic communication networks, such as the Internet. An example of an exchange specific computer system is illustrated in FIG. 1.

Once matched and executed, the executed trade is transmitted to a clearing corporation that stands between the holders and writers of derivative contracts. When exchange traded derivatives are exercised, the cash or underlying assets are delivered, when necessary, to the clearing corporation and the clearing corporation disperses the assets as appropriate and defined by the consequence(s) of the trades.

An option contract gives the contract holder a right, but not an obligation, to buy or sell an underlying asset at a specific price on or before a certain date, depending on the option style (e.g., American or European). Conversely, an option contract obligates the seller of the contract to deliver an underlying asset at a specific price on or before a certain date, depending on the option style (e.g., American or European). An American style option may be exercised at any time prior to its expiration. A European style option may be exercised only at its expiration, i.e., at a single pre-defined point in time.

There are generally two types of options: calls and puts. A call option conveys to the holder a right to purchase an underlying asset at a specific price (i.e., the strike price), and obligates the writer to deliver the underlying asset to the holder at the strike price. A put option conveys to the holder a right to sell an underlying asset at a specific price (i.e., the strike price), and obligates the writer to purchase the underlying asset at the strike price.

There are generally two types of settlement processes: physical settlement and cash settlement. During physical settlement, funds are transferred from one party to another in exchange for the delivery of the underlying asset. During cash settlement, funds are delivered from one party to another according to a calculation that incorporates data concerning the underlying asset.

A futures contract gives a buyer of the future an obligation to receive delivery of an underlying commodity or asset on a fixed date in the future. Accordingly, a seller of the future contract has the obligation to deliver the commodity or asset on the specified date for a given price. Futures may be settled using physical or cash settlement. Both options and futures contracts may be based on abstract market indicators, such as indices.

A single-name credit default swap (“CDS”) contract gives the buyer insurance against loss arising from a credit event, such as bankruptcy and debt restructuring, of a particular obligor over a fixed period of time in exchange for making periodic premium payments to the seller. A CDS may be settled using physical or cash settlement. A basket CDS contract, also known as a CDS index contract, gives the buyer insurance against loss arising from credit events by any of the multiple single-name constituents during the term of the contract. Whenever a constituent experiences a credit event, the obligor is removed from the basket and the basket continues to be traded with a prorated notional amount.

An index is a statistical composite that is used to indicate the performance of a market or a market sector over various time periods, i.e., act as a performance benchmark. Examples of indices include the Dow Jones Industrial Average, the National Association of Securities Dealers Automated Quotations (“NASDAQ”) Composite Index, and the Standard & Poor's 500 (“S&P 500®”). As noted above, options on indices are generally cash settled. For example, using cash settlement, a holder of an index call option receives the right to purchase not the index itself, but rather a cash amount equal to the value of the index multiplied by a multiplier, e.g., $100. Thus, if a holder of an index call option exercises the option, the writer of the option must pay the holder, provided the option is in-the-money, the difference between the current value of the underlying index and the strike price multiplied by a multiplier.

Among the indices that derivatives may be based on are those that gauge the volatility of a market or a market subsection. For example, CBOE created and disseminates the CBOE Market Volatility Index or VIX®, which is a key measure of market expectations of near-term volatility conveyed by S&P 500 stock index options prices. Additionally, CBOE offers exchange traded derivative products (both futures and options) that use the VIX as the underlying asset. Volatility indices and the derivative products based thereon have been widely accepted by the financial industry as both a useful tool to hedge positions and as a device for expressing investment views on the direction of volatility.

### BRIEF SUMMARY

The inventors have appreciated that, while several volatility indices exist, there currently exists no implementation of a volatility gauge for credit default swaps (“CDSs”) or CDS indexes that is theoretically consistent with prices prevailing in existing markets for options on credit derivatives such as single-name CDS and CDS indexes. Particularly, no standardized benchmarks exist to estimate credit volatility over a given investment horizon and term of the credit derivative. Because no standardized benchmark currently exists that reflects the option-implied fair market value of expected credit volatility, traders, other market participants, and/or money managers currently trade options on CDS to hedge other financial positions, facilitate market-making, and/or take particular investment positions related to market volatility. However, the strategies employed in attempting to hedge risk via the trading of options on CDS and CDS indexes do not necessarily lead to accurate profits and losses due to price dependency, i.e., the tendency to generate profits and losses that are affected by the path of price movements between trade inception and expiry dates rather than the absolute price level prevailing at the time of option expiry.

As such, some embodiments of the invention provide techniques for calculating an effective volatility index related to credit. Additionally, some embodiments of the invention provide techniques for instantiating and/or facilitating trading of derivative products based on such an index.

In some embodiments, techniques are provided for creating and disseminating one or more volatility indices calculated using data for options on credit derivatives (i.e., an option granting its owner the right but not the obligation to enter into an underlying credit derivative contract), and facilitating the electronic creation and trading of derivative products based on one or more indices relating to volatility.

Additional features and advantages of the invention will be set forth in the description that follows, and in part will be apparent from the description, or may be learned by practice of the invention. The objectives and advantages of the invention will be realized and attained by the method that is particularly pointed out in the written description and claims hereof as well as the appended drawings.

To achieve these and other advantages, and in accordance with the purpose of the invention, as embodied and broadly described, the present invention provides a computer system for calculating a credit volatility index comprising memory configured to store at least one program; and at least one processor communicatively coupled to the memory, in which the at least one program, when executed by the at least one processor, causes the at least one processor to receive data regarding options on credit default swap index derivatives; calculate, using the data regarding options on credit default swap index derivatives, the credit volatility index; and transmit data regarding the credit volatility index.

In some embodiments the data regarding options on credit default swap index derivatives includes data regarding prices of options on credit default swap index derivatives.

In some embodiments the data regarding prices of options on credit default swap index derivatives includes data regarding prices of European style options on credit default swap index forwards.

In some embodiments the data regarding prices of options on credit default swap index derivatives includes data regarding prices of options that are not European style options on credit default swap index forwards.

In some embodiments when the data regarding prices of options on credit default swap derivatives includes data regarding prices of options that are not European-style options on credit default swap index forwards, converting the data regarding prices of options that are not European-style options on credit default swap index forwards to data regarding prices of European style options on credit default swap index forwards.

In some embodiments calculating the credit volatility index includes valuing a basket of options on the credit default swap derivatives required for model-independent pricing of a variance swap contract on the credit default swap derivatives.

In another embodiment, the credit volatility index is calculated at time t according to the equation:

$$C - VI ( t , T , {T}_{D} , M ) ≡ 100 \times \sqrt{\frac{1}{( T - t )} [ \begin{matrix}\frac{2}{{v}_{1 , t}} [ \begin{matrix}{\sum }_{i : Ki < {K}_{*}} \frac{{SW}_{t}^{r} ( {K}_{i} , T , {T}_{D} ; M )}{{K}_{i}^{2}} Δ {K}_{i} + \\ {\sum }_{i : {K}_{i} \geq {K}_{*}} \frac{{SW}_{t}^{p} ( {K}_{i} , T , {T}_{D} ; M )}{{K}_{i}^{2}} Δ {K}_{i}\end{matrix} ] - \\ {( \frac{{CDX}_{t} ( {T}_{D} , M ) - {K}_{*}}{{K}_{*}} )}^{2}\end{matrix} ]}$$

wherein:

t denotes a time at which the credit volatility index is calculated;

T denotes a time of expiry of options on credit default swap index derivatives;

T_{D} denotes a time of maturity of credit default swap index derivatives underlying the options where T_{D}≧T;

M denotes a time of expiry of credits default swap indexes;

Z+1 denotes a total number of options used in the index calculation;

K₀ denotes the lowest strike of the Z+1 options;

Kᵢ denotes the highest strike of the Z+1 options;

K_{Z} denotes the highest strike of the Z+1 options;

$$Δ {K}_{i} = \frac{1}{2} ( {K}_{i + 1} - {K}_{i - 1} )$$

for i≧1; and ΔK₀=(K₁−K₀), ΔK_{Z}=(K_{Z}−K_{Z-1});

if the price is observable at time t, then CDXₜ(T_{D},M) is a price at time t of a credit default swap index derivative underlying the put and call options, expiring at T_{D} with an underlying credit default swap index maturing at M;
if the price is not observable at time t, then CDXₜ(T_{D},M) is the spread at which the difference between the put and call prices is smallest;
if there exists an option struck at CDXₜ(T_{D},M), then K_{*} equals CDXₜ(T_{D},M);

if there does not exist an option struck at CDXₜ(T_{D},M), then K_{*} is the first available strike below CDXₜ(T_{D},M);

v_{1,t} is a price value of a basis point at time t, adjusted for default risk, of the credit default swap index premium payments;

SWₜ^{r}(Kᵢ,T,T_{D};M) is a price at time t of a receiver option, struck at Kᵢ, expiring at T, and having an underlying credit default swap index derivative expiring at T_{D} with an underlying credit default swap index maturing at M;

SWₜ^{p}(Kᵢ,T,T_{D};M) is a price at time t of a payer option, struck at Kᵢ, expiring at T, and having an underlying credit default swap index derivative expiring at T_{D} with an underlying credit default swap index maturing at M; and

C-VI(t,T,T_{D},M) is the value of the credit volatility index at time t calculated based on options expiring at T on credit default swap index derivatives expiring at T_{D} with an underlying credit default swap index maturing at M.

In some embodiments the credit volatility index is calculated at time t according to the equation:

$$C - {VI}^{bp} ( t , T , {T}_{D} , M ) ≡ {100}^{2} \times \\ \sqrt{\frac{1}{( T - t )} [ \frac{2}{{v}_{1 , t}} [ {\sum }_{i : {K}_{i} < {K}_{*}} {SW}_{t}^{r} ( {K}_{i} , T , {T}_{D} ; M ) Δ {K}_{i} {\sum }_{i : {K}_{i} \geq {K}_{*}} {SW}_{t}^{p} ( {K}_{i} , T , {T}_{D} ; M ) Δ {K}_{i} ] - {( {CDX}_{t} ( {T}_{D ,} M ) - {K}_{*} )}^{2} ]}$$

wherein:

t denotes a time at which the credit volatility index is calculated;

T denotes a time of expiry of options on credit default swap index derivatives;

T_{D} denotes a time of maturity of credit default swap index derivatives underlying the options where T_{D}≧T;

M denotes a time of expiry of credits default swap indexes;

Z+1 denotes a total number of options used in the index calculation;

K₀ denotes the lowest strike of the Z+1 options;

Kᵢ denotes the i^{th} highest strike of the Z+1 options;

K_{Z} denotes the highest strike of the Z+1 options;

$$Δ {K}_{i} = \frac{1}{2} ( {K}_{i + 1} - {K}_{i - 1} )$$

for i≧1, and ΔK₀=(K₁−K₀), ΔK_{Z}=(K_{Z}−K_{Z-1});

if the price is observable at time t, then CDXₜ(T_{D},M) is a price at time t of a credit default swap index derivative underlying the put and call options, expiring at T_{D} with an underlying credit default swap index maturing at M;

if the price is not observable at time t, then CDXₜ(T_{D},M) is the spread at which the difference between the put and call prices is smallest;

if there exists an option struck at CDXₜ(T_{D},M), then K_{*} equals CDXₜ(T_{D},M);

if there does not exist an option struck at CDXₜ(T_{D},M), then K_{*} is the first available strike below CDXₜ(T_{D},M);

v_{1,t} is a price value of a basis point at time t, adjusted for default risk, of the credit default swap index premium payments;

SWₜ^{r}(Kᵢ,T,T_{D};M) is a price at time t of a receiver option, struck at Kᵢ, expiring at T, and having an underlying credit default swap index derivative expiring at T_{D} with an underlying credit default swap index maturing at M;

SWₜ^{p}(Kᵢ,T,T_{D};M) is a price at time t of a payer option, struck at Kᵢ, expiring at T, and having an underlying credit default swap index derivative expiring at T_{D} with an underlying credit default swap index maturing at M; and

C-VI^{bp}(t,T,T_{D},M) is the value of the credit volatility index at time t calculated based on options expiring at T on credit default swap index derivatives expiring at T_{D} with an underlying credit default swap index maturing at M.

In some embodiments the at least one processor is further caused to create a standardized exchange-traded derivative instrument based on the credit volatility index; and transmit data regarding the standardized exchange-traded derivative.

In some embodiments transmitting data regarding the standardized exchange-traded derivative instrument includes transmitting data regarding one or more of a settlement price, a bid price, an offer price, or a trade price of the standardized exchange-traded derivative instrument.

In another embodiment, a non-transitory computer readable storage medium having computer-executable instructions recorded thereon that, when executed on a computer, configure the computer to perform a method to calculate a credit volatility index, the method comprising receiving data regarding options on credit default swap index derivatives; calculating, using the data regarding options on credit default swap index derivatives, the credit volatility index; and transmitting data regarding the credit volatility index.

In some embodiments of the non-transitory computer readable storage medium the data regarding options on credit default swap index derivatives includes data regarding prices of options on credit default swap index derivatives.

In some embodiments of the non-transitory computer readable storage medium the data regarding prices of options on credit default swap index derivatives includes data regarding prices of European style options on credit default swap index forwards.

In some embodiments of the non-transitory computer readable storage medium the data regarding prices of options on credit default swap index derivatives includes data regarding prices of options that are not European-style options on credit default swap index forwards.

In some embodiments of the non-transitory computer readable storage medium when the data regarding prices of options on credit default swap index derivatives includes data regarding prices of options that are not European-style options on credit default swap index forwards, converting the data regarding prices of options that are not European-style options on credit default swap index forwards to data regarding prices of European style options on credit default swap index forwards.

In some embodiments of the non-transitory computer readable storage medium calculating the credit volatility index includes valuing a basket of options on the credit default swap index derivatives required for model-independent pricing of a variance swap contract on the credit default swap index derivatives.

In some embodiments of the non-transitory computer readable storage medium, the credit volatility index is calculated at time t according to the equation:

$$C - VI ( t , T , {T}_{D} , M ) ≡ {100}^{2} \times \sqrt{\frac{1}{( T - t )} [ \frac{2}{{v}_{1 , t}} [ {\sum }_{i : Ki < {K}_{*}} \frac{{SW}_{t}^{r} ( {K}_{i} , T , {T}_{D} ; M )}{{K}_{i}^{2}} Δ {K}_{i} + {\sum }_{i : Ki \geq {K}_{*}} \frac{{SW}_{t}^{p} ( {K}_{i} , T , {T}_{D} ; M )}{{K}_{i}^{2}} Δ {K}_{i} ] - {( \frac{( {CDX}_{t} ( {T}_{D ,} M ) - {K}_{*} )}{{K}_{*}} )}^{2} ]}$$

wherein:

t denotes a time at which the credit volatility index is calculated;

T denotes a time of expiry of options on credit default swap index derivatives;

T_{D} denotes a time of maturity of credit default swap index derivatives underlying the options where T_{D}≧T;

M denotes a time of expiry of credits default swap indexes;

Z+1 denotes a total number of options used in the index calculation;

K₀ denotes the lowest strike of the Z+1 options;

Kᵢ denotes the highest strike of the Z+1 options;

K_{Z} denotes the highest strike of the Z+1 options;

$$Δ {K}_{i} = \frac{1}{2} ( {K}_{i + 1} - {K}_{i - 1} )$$

for i≧1, and ΔK₀=(K₁−K₀), ΔK_{Z}=(K_{Z}−K_{Z-1});

if the price is observable at time t, then CDXₜ(T_{D},M) is a price at time t of a credit default swap index derivative underlying the put and call options, expiring at T_{D} with an underlying credit default swap index maturing at M;

if the price is not observable at time t, then CDXₜ(T_{D},M) is the spread at which the difference between the put and call prices is smallest;
if there exists an option struck at CDXₜ(T_{D},M), then K_{*} equals CDXₜ(T_{D},M);

if there does not exist an option struck at CDXₜ(T_{D},M), then K_{*} is the first available strike below CDXₜ(T_{D},M);

v_{1,t} is a price value of a basis point at time t, adjusted for default risk, of the credit default swap index premium payments;

SWₜ^{r}(Kᵢ,T,T_{D};M) is a price at time t of a receiver option, struck at Kᵢ, expiring at T, and having an underlying credit default swap index derivative expiring at T_{D} with an underlying credit default swap index maturing at M;

SWₜ^{p}(Kᵢ,T,T_{D};M) is a price at time t of a payer option, struck at Kᵢ, expiring at T, and having an underlying credit default swap index derivative expiring at T_{D} with an underlying credit default swap index maturing at M; and

C-VI(t,T,T_{D},M) is the value of the credit volatility index at time t calculated based on options expiring at T on credit default swap index derivatives expiring at T_{D} with an underlying credit default swap index maturing at M.

In some embodiments of the non-transitory computer readable storage medium, the credit volatility index is calculated at time t according to the equation:

$$C - {VI}^{bp} ( t , T , {T}_{D} , M ) ≡ {100}^{2} \times \\ \sqrt{\frac{1}{( T - t )} [ \frac{2}{{v}_{1 , t}} [ {\sum }_{i : {K}_{i} < {K}_{*}} {SW}_{t}^{r} ( {K}_{i} , T , {T}_{D} ; M ) Δ {K}_{i} + {\sum }_{i : {K}_{i} \geq {K}_{*}} {SW}_{t}^{p} ( {K}_{i} , T , {T}_{D} ; M ) Δ {K}_{i} ] - {( {CDX}_{t} ( {T}_{D ,} M ) - {K}_{*} )}^{2} ]}$$

wherein:

t denotes a time at which the credit volatility index is calculated;

T denotes a time of expiry of options on credit default swap index derivatives;

T_{D} denotes a time of maturity of credit default swap index derivatives underlying the options where T_{D}≧T;

M denotes a time of expiry of credits default swap indexes;

Z+1 denotes a total number of options used in the index calculation;

K₀ denotes the lowest strike of the Z+1 options;

Kᵢ denotes the i^{th} highest strike of the Z+1 options;

K_{Z} denotes the highest strike of the Z+1 options;

$$Δ {K}_{i} = \frac{1}{2} ( {K}_{i + 1} - {K}_{i - 1} )$$

for i≧1; and ΔK₀=(K₁−K₀), ΔK_{Z}=(K_{Z}−K_{Z-1});

if the price is observable at time t, then CDXₜ(T_{D},M) is a price at time t of a credit default swap index derivative underlying the put and call options, expiring at T_{D} with an underlying credit default swap index maturing at M;

if the price is not observable at time t, then CDXₜ(T_{D},M) is the spread at which the difference between the put and call prices is smallest;

if there exists an option struck at CDXₜ(T_{D},M), then K_{*} equals CDXₜ(T_{D},M);

if there does not exist an option struck at CDXₜ(T_{D},M), then K_{*} is the first available strike below CDXₜ(T_{D},M);

v_{1,t} is a price value of a basis point at time t, adjusted for default risk, of the credit default swap index premium payments;

SWₜ^{r}(Kᵢ,T,T_{D};M) is a price at time t of a receiver option, struck at Kᵢ, expiring at T, and having an underlying credit default swap index derivative expiring at T_{D} with an underlying credit default swap index maturing at M;

SWₜ^{p}(Kᵢ,T,T_{D};M) is a price at time t of a payer option, struck at Kᵢ, expiring at T, and having an underlying credit default swap index derivative expiring at T_{D} with an underlying credit default swap index maturing at M; and

C-VI^{bp}(t,T,T_{D},M) is the value of the credit volatility index at time t calculated based on options expiring at T on credit default swap index derivatives expiring at T_{D} with an underlying credit default swap index maturing at M.

In some embodiments of the non-transitory computer readable storage medium the at least one processor is further caused to create a standardized exchange-traded derivative instrument based on the credit volatility index; and transmit data regarding the standardized exchange-traded derivative.

In some embodiments of the non-transitory computer readable storage medium transmitting data regarding the standardized exchange-traded derivative instrument includes transmitting data regarding one or more of a settlement price, a bid price, an offer price, or a trade price of the standardized exchange-traded derivative instrument.

The foregoing is a non-limiting summary of the invention, some embodiments of which are defined by the attached claims.

### BRIEF DESCRIPTION OF THE DRAWINGS

FIG. 1 is a diagram of a financial exchange's computerized trading system;

FIG. 2 is a diagram of a financial exchange's back end trading system;

FIG. 3 is a flow diagram of a method of calculating a Basis Point Credit Volatility Index;

FIG. 4 is a flow diagram of a method of calculating a Percentage Credit Volatility Index; and

FIG. 5 is a diagram of a general purpose computer system that can be modified via computer hardware or software to be customized and specialized so as to be suitable for use in a financial exchanges computerized trading system.

### DETAILED DESCRIPTION OF THE PREFERRED EMBODIMENTS

Some embodiments of the present invention can be implemented on financial exchange systems and/or other known financial industry systems, whether now known or later developed. Typically, financial exchange systems and other known financial industry systems utilize a combination of computer hardware (e.g., client and server computers, which may include computer processors, memory, storage, input and output devices, and other known components of computer systems; electronic communication equipment, such as electronic communication lines, routers, switches, etc; electronic information storage systems, such as network-attached storage and storage area networks) and computer software (i.e., the instructions that cause the computer hardware to function in a specific way) to achieve the desired system performance. It should be noted that financial exchange systems may be floor-based open outcry systems, pure electronic systems, or some combination of floor-based open outcry and pure electronic systems.

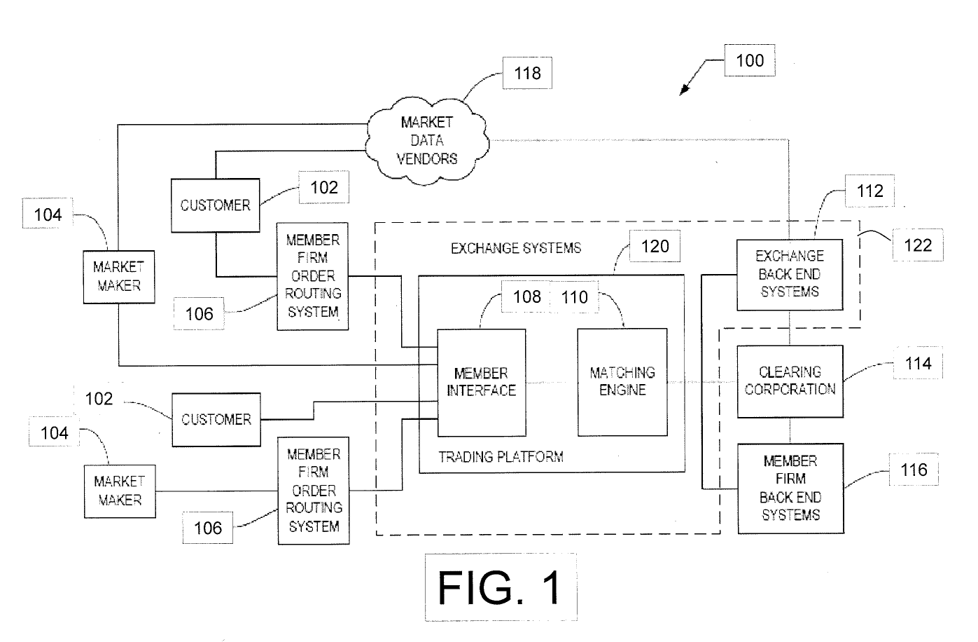

FIG. 1 illustrates an electronic trading system 100 which may be used for creating and disseminating a CDS index option-based index (such as a credit volatility index) and/or creating, listing and trading derivative contracts that are based on a CDS index option index. One having ordinary skill in the art would readily understand that system 100, as described in detail below, would be implemented utilizing a combination of computer hardware and software, as described in the paragraph above. It will be appreciated that the described systems may implement the methods described below.

The system 100 includes components operated by an exchange, as well as components operated by others who access the exchange to execute trades. The components shown within the dashed lines are those operated by the exchange. Components outside the dashed lines are operated by others, but nonetheless are necessary for the operation of a functioning exchange. The exchange components 122 of the trading system 100 include an electronic trading platform 120, a member interface 108, a matching engine 110, and backend systems 112. Backend systems not operated by the exchange but which are integral to processing trades and settling contracts are the Clearing Corporation's systems 114, and Member Firms' backend systems 116.

Market Makers may access the trading platform 120 directly through personal input devices 104 which communicate with the member interface 108. Market makers may quote prices for the derivative contracts of the present invention, e.g. credit volatility index derivative contracts. Non-member Customers 102, however, must access the exchange through a Member Firm. Customer orders are routed through Member Firm routing systems 106. The Member Firm routing systems 106 forward the orders to the exchange via the member interface 108. The member interface 108 manages all communications between the Member Firm routing systems 106 and Market Makers' personal input devices 104; determines whether orders may be processed by the trading platform; and determines the appropriate matching engine for processing the orders. Although only a single matching engine 110 is shown in system 100, the trading platform 120 may include multiple matching engines. Different exchange traded products may be allocated to different matching engines for efficient execution of trades. When the member interface 102 receives an order from a Member Firm routing system 106, the member interface 108 determines the proper matching engine 110 for processing the order and forwards the order to the appropriate matching engine. The matching engine 110 executes trades by pairing corresponding marketable buy/sell orders. Non-marketable orders are placed in an electronic order book.

Once orders are executed, the matching engine 110 sends details of the executed transactions to the exchange backend systems 112, to the Clearing Corporation systems 114, and to the Member Firm backend systems 116. The matching engine also updates the order book to reflect changes in the market based on the executed transactions. Orders that previously were not marketable may become marketable due to changes in the market. If so, the matching engine 110 executes these orders as well.

The exchange backend systems 112 perform a number of different functions. For example, contract definition and listing data originate with the Exchange backend systems 112. The CDS index option-based indices of the present invention, e.g., the Credit volatility indices described below, and pricing information for derivative contracts associated with the indices of the present invention are disseminated from the exchange backend systems to market data vendors 118. Customers 102, market makers 104, and others may access the market data regarding the indices of the present invention and the derivative contracts based on the indices of the present invention via, for example, proprietary networks, on-line services, and the like.

The exchange backend systems also evaluate the underlying asset or assets on which the derivative contracts of the present invention are based. At expiration, the backend systems 112 determine the appropriate settlement amounts and supply final settlement data to the Clearing Corporation 114. The Clearing Corporation 114 acts as the exchange's bank and performs a final mark-to-market on Member Firm margin accounts based on the positions taken by the Member Firms' customers. The final mark-to-market reflects the final settlement amounts for the derivative contracts of the present invention, and the Clearing Corporation debits/credits Member Firms' accounts accordingly. These data are also forwarded to the Member Firms' systems 116 so that they may update their customer accounts as well.

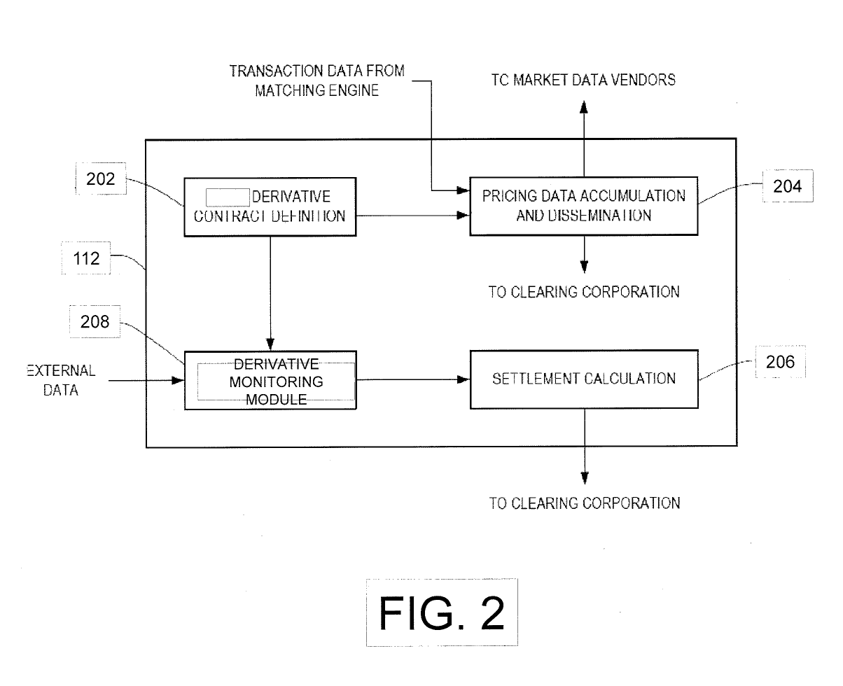

FIG. 2 shows an embodiment of the exchange backend systems 112 used for creating and disseminating an index of the present invention, e.g., a Credit volatility index, and/or creating, listing, and trading derivative contracts that are based on an index of the present invention. A derivative contract of the present invention has a definition stored in module 202 that contains all relevant data concerning the derivative contract to be traded on the trading platform 120, including, for example, the contract symbol, a definition of the underlying asset or assets associated with the derivative, or a term of a calculation period associated with the derivative. A pricing data accumulation and dissemination module 204 receives contract information from the derivative contract definition module 202 and transaction data from the matching engine 110. The pricing data accumulation and dissemination module 204 provides the market data regarding open bids and offers and recent transactions to the market data vendors 118. The pricing data accumulation and dissemination module 204 also forwards transaction data to the Clearing Corporation 114 so that the Clearing Corporation 114 may mark-to-market the accounts of Member Firms at the close of each trading day, taking into account current market prices for the derivative contracts of the present invention. Finally, a settlement calculation module 206 receives input from the derivative monitoring module 208. On the settlement date the settlement calculation module 206 calculates the settlement amount based on the value associated with the underlying asset or assets, e.g., the value of a Credit volatility index. The settlement calculation module 206 forwards the settlement amount to the Clearing Corporation 114, which performs a final mark-to-market on the Member Firms' accounts to settle the derivative contract of the present invention.

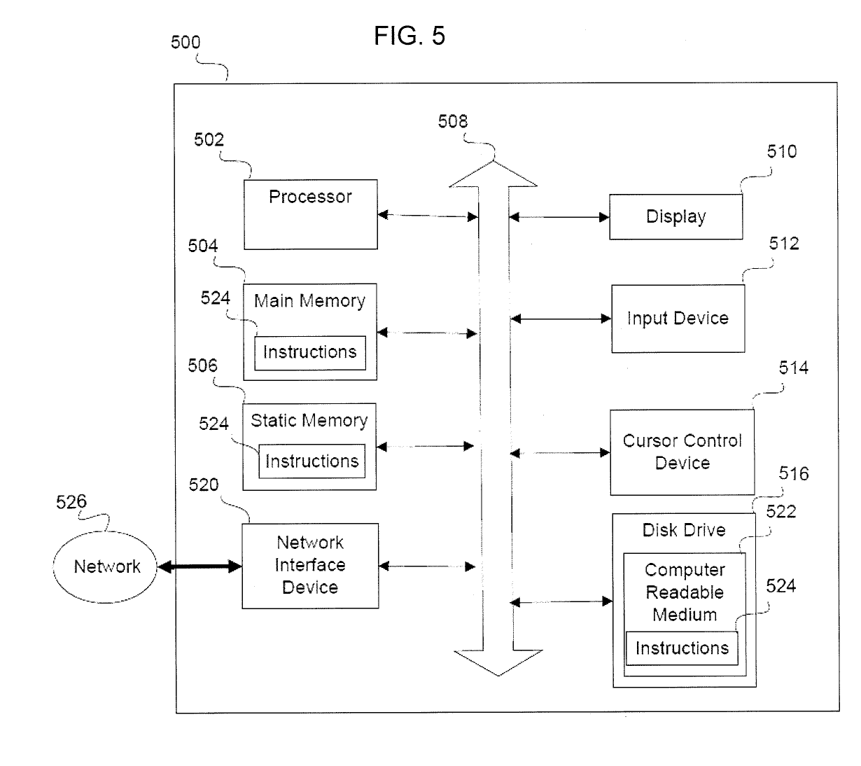

Referring to FIG. 5, an illustrative embodiment of a general computer system that may be used for one or more of the components shown in FIG. 1, or in any other trading system configured to carry out the methods discussed in further detail below, is shown and is designated 500. The computer system 500 can include a set of instructions that can be executed to cause the computer system 500 to perform any one or more of the methods or computer based functions disclosed herein. The computer system 500 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 500 can also be implemented as or incorporated into various devices, such as a personal computer (“PC”), a tablet PC, a set-top box (“STB”), a personal digital assistant (“PDA”), a mobile device, a palmtop computer, a laptop computer, a desktop computer, a network router, switch or bridge, or any other machine capable of executing a set of instructions (sequential or otherwise) that specify actions to be taken by that machine. In a particular embodiment, the computer system 500 can be implemented using electronic devices that provide voice, video or data communication. Further, while a single computer system 500 is illustrated, the term “system” shall also be taken to include any collection of systems or sub-systems that individually or jointly execute a set, or multiple sets, of instructions to perform one or more computer functions.

As illustrated in FIG. 5, the computer system 500 may include a processor 502, such as a central processing unit (“CPU”), a graphics processing unit (“GPU”), or both. Moreover, the computer system 500 can include a main memory 504 and a static memory 506 that can communicate with each other via a bus 508. As shown, the computer system 500 may further include a video display unit 510, such as a liquid crystal display (“LCD”), an organic light emitting diode (“OLED”), a flat panel display, a solid state display, or a cathode ray tube (“CRT”). Additionally, the computer system 500 may include an input device 512, such as a keyboard, and a cursor control device 514, such as a mouse. The computer system 500 can also include a disk drive unit 516, a signal generation device 518, such as a speaker or remote control, and a network interface device 520.

In a particular embodiment, as depicted in FIG. 5, the disk drive unit 516 may include a computer-readable medium 522 in which one or more sets of instructions 524, e.g., software, can be embedded. Further, the instructions 524 may embody one or more of the methods or logic as described herein. In a particular embodiment, the instructions 524 may reside completely, or at least partially, within the main memory 504, the static memory 506, and/or within the processor 502 during execution by the computer system 500. The main memory 504 and the processor 502 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 524 or receives and executes instructions 524 responsive to a propagated signal, so that a device connected to a network 526 can communicate voice, video or data over the network 526. Further, the instructions 524 may be transmitted or received over the network 526 via the network interface device 520.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture information communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols commonly used by investment management companies, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

According to one embodiment, systems and methods are provided for calculating and disseminating credit volatility indices. Credit volatility indices (“C-VI”) may be calculated and disseminated using the systems shown in FIGS. 1, 2, and 5 and described in detail above. Generally, the C-VIs reflect the fair value of contracts for delivery of realized volatility of forward CDS index spreads, and reflect the expected volatility of forward CDS index spreads within arbitrary investment horizons. According to embodiments of the present invention, C-VIs can be calculated for any CDS index for which options markets exist. According to an embodiment of the present invention, the C-VI is calculated based on data relating to a market for options on CDS indexes. For example, the C-Vis would be particularly well suited for indexes such as the Markit CDX™ and Markit iTraxx™ indexes owned by Markit Group Limited.

According to some embodiment of the present invention, the C-VIs are calculated, for each maturity-tenor combination (maturity of the option and tenor of the underlying CDS index) on the “volatility surface,” by aggregating the price of at-the-money and out of-the money receiver and payer options on CDS indexes (i.e., the option “skew,” the “volatility skew”) into a single formula, which is independent of any option pricing model. These C-VIs match the prevailing market practices to quote volatility in fixed income markets in terms of either basis point volatility or percentage volatility. Moreover, the C-VIs described herein can reflect the fair market value of contracts for future delivery of CDS index spread volatility, at each point of the volatility surface, i.e., over any arbitrary maturity date and tenor of the CDS index.

According to an embodiment of the present invention, the C-VIs are constructed using the prices of a broad set of CDS index options, including at-the-money and out-of-the money options. Thus, according to an embodiment of the present invention, the C-VIs reduce the dimensions of the “volatility cube” in the CDS index option markets from three down to two, where a three dimensional relationship structure is reduced down to a two dimensional relationship structure. The “volatility cube” represents the relationship between the implied volatility of CDS index options and: (i) time to expiration of the CDS index option, (ii) time to expiration of the CDS index underlying the option, and (iii) the strike of the CDS index option. It is the dimension of the “volatility cube” that represents the relationship between the implied volatility of CDS index options and the strike of the CDS index options that is reduced by collapsing this dimension (iii) into a single point for each combination of dimensions (i)-(ii).

A buyer of protection on a CDS index, also known as basket or portfolio CDS, pays a periodic premium (“CDS index spread”) to the seller in exchange for insurance against losses arising from one or more defaults from a basket of single-name CDS, also known as index constituents, during the term of the contract. Whenever a constituent defaults, the defaulted obligor is removed from the index and the index continues to be traded with a prorated notional amount. Hence, the number of surviving names in the index, S(Tᵢ) at some future date Tᵢ is uncertain and can be expressed as,

$$S ( {T}_{i} ) ≡ {\sum }_{j = 1}^{n} ( 1 - {I}_{\{ {τ}_{j} \leq {T}_{i} \}} )$$

where n is the starting number at initial time t=T₀ of the index constituents and τⱼ is the random default time of the j-th constituent and I_{{τj≦T}_{ᵢ}_{}}, is the indicator function that takes a value of 1 if default takes place before Tᵢ.
At initial time t, the value of the CDS index contract for the protection buyer minus that of the protection seller over the life of the contract is

$${DSX}_{t} ≡ {E}_{t} [ {\sum }_{j = 1}^{n} exp ( - {\int }_{t}^{{τ}_{j}} r ( s ) d s ) ( LGD \frac{1}{n} {I}_{\{ t \leq {τ}_{j} \leq {T}_{bM} \}} ] - {E}_{t} [ {\sum }_{i = 1}^{bM} exp ( - {\int }_{t}^{{T}_{i}} r ( s ) d s ) ( \frac{1}{b} {\overline{CDX}}_{t} ( M ) ) \frac{1}{n} S ( {T}_{i} ) ) ]$$

where M is the maturity in years, b is the number of premium payments per annum, and T_{bM}−T₀ is the time to expiry of the CDS; T₁−T₀, . . . , T_{bM}-T_{bM-1} are the premium payment dates; LDG is the fraction of principal lost at default; τⱼ represents the time of default by firm j, which follows a Cox process with constant default intensity λ adapted to r; r(s) is the short-term rate following a diffusion process; I_{{t≦τ≦T}_{_{bM}}_{}} an indicator function that takes a value of 1 if the condition in the subscript, i.e. default occurs before maturity, holds true and zero otherwise; and Eₜ is the expectation conditional on information up to time t; C̅D̅S̅ₜ(M) is the premium per annum expressed in decimals.

DSXₜ may be recast in terms of a hypothetical firm with default risk that is representative of the CDS index constituents

$${DSX}_{t} = LGD \cdot {v}_{0 , t , t} - \frac{1}{b} {\overline{CDX}}_{t} ( M ) \cdot {v}_{1 , t}$$

$$where$$

$${v}_{0 , {T}_{A} , {T}_{B}} ≡ {E}_{{T}_{A}} [ exp ( - {\int }_{{T}_{A}}^{{τ}_{*}} r ( s ) d s ) ( {I}_{\{ {T}_{B}} \leq {τ}_{*} \leq {T}_{bM \}} ) ] , \\ {v}_{1 , t} ≡ {\sum }_{i = 1}^{bM} {E}_{t} [ exp ( - {\int }_{t}^{{T}_{i}} r ( s ) d s ) \cdot {I}_{\{ Surv * \_at \_Ti \}} ]$$

where τ_{*} is the random default time of a representative firm with default intensity parameter λ and l_{{Surv*}_{_{—}}ₐₜ_{_{—}}_{T}_{ᵢ}_{}}, is l if the representative firm has survived up to time Tᵢ and 0 otherwise. The interpretation of v_{0,T}_{_{A}}_{,T}_{_{B}} is the expected present value at time T_{A} of receiving one dollar if the representative firm defaults between T_{B} and maturity T_{bM}. The interpretation of v_{1,t} is the expected present value at time t of receiving one dollar on each Tᵢ until the earlier of default or maturity, which can be interpreted as the price value of a basis point (PVBP) adjusted for default risk.

A forward CDS index spread is the premium at which a protection buyer buys protection on the CDS index starting at a future date. If a protection buyer enters, at time t, into a M-year forward CDS index to start at time T with annualized premium equal to C̅D̅X̅ₜ(M), then the value of the protection leg minus the premium leg at any time s, sε(t,T), is

$${DSX}_{s , T} ≡ N ( s ) \cdot ( LGD \cdot {v}_{0 , s , T} - \frac{1}{b} {\overline{CDX}}_{t} ( M ) \cdot {v}_{1 , s} )$$

where N(s) denotes the outstanding notional at time s

$$N ( s ) = \frac{1}{N} S ( s ) , N ( t ) ≡ 1$$

A payer (receiver) CDS index option gives the option holder the right but not obligation to buy (sell) protection on the CDS index on a future date at a fixed spread K, i.e. the strike. If the option holder buys a payer at time t that matures at time T>t, the option holder is entitled to receive “front-end protection” upon exercise at maturity, which is equal to the value of any losses from default of one or more of the CDS index's constituents between t and T. Mathematically, if

D(t,T)≡Σⱼ₌₁ⁿI_{{τjε(t,T)}}

is the number of defaults in time interval (t,T) then the payout at time T of the front-end protection is

$${F}_{T} ≡ LGD \cdot \frac{1}{n} \cdot D ( t , T )$$

and the value of F_{T} at time s is

$$\begin{matrix}{v}_{s}^{F} ≡ {E}_{s} [ exp ( - {\int }_{s}^{T} r ( u ) d u ) \cdot {F}_{T} ] \\ = LGD ( \frac{1}{n} D ( t , s ) P ( s , T ) + N ( s ) ( P ( s , T ) - {P}_{def} ( s , T ) ) )\end{matrix}$$

where P(s,T) is the price at time s of a non-defaultable zero coupon bond expiring at time T and P_{def}(s,T) is the price at time s of a defaultable zero-coupon bonds expiring at time T with LGD=1 and default intensity λ. This gives rise to a loss-adjusted forward CDS index defined as

DSX_{s,T}^{L}≡DSX_{s,T}+vₛ^{F}.

If we define CDXₛ(M) as the value of C̅D̅X̅ₜ(M) such that DSX_{s,T}^{L}=0, then

$$\frac{1}{b} {CDX}_{s} ( M ) = LDG \frac{{v}_{0 , s , T}}{{v}_{1 , s}} + \frac{{v}_{s}^{F}}{N ( s ) {v}_{1 , s}}$$

$$and$$

$${DSX}_{s , T}^{L} = \frac{1}{b} N ( s ) {v}_{1 , s} ( {CDX}_{s} ( M ) - {\overline{CDX}}_{s} ( M ) )$$

We define the “survival contingent probability measure” \hat{Q}_{sc} such that

$$\frac{d {\hat{Q}}_{sc}}{d Q} {\vert}_{{F}_{T}^{r}} = exp ( - {\int }_{s}^{T} r ( u ) d u ) \cdot \frac{N ( T ) \cdot {v}_{1 , T}}{N ( s ) \cdot {v}_{1 , s}}$$

where F_{T}^{r} is the information set at time T generated by the short rate process r(s) and CDXₛ(M) is a martingale under this probability.

The price of a payer with strike K expiring at T on a M-year CDS index is

SWₛ^{p}(K,T;M)≡N(s)v_{1,s}·Êₛ^{sc}[(CDX_{T}(M)−K)⁺],sε[t,T]

and the price of a receiver with strike K expiring at T on a M-year CDS index is

SWₛ^{r}(K,T;M)≡N(s)v_{1,s}·Êₛ^{sc}[(K−CDX_{T}(M))⁺],sε[t,T]

where Êₛ^{sc} is the expectation under measure \hat{Q}_{sc} conditional on information up to time s.

Once we assume that CDXₜ(M) is a geometric Brownian motion with constant volatility under the survival contingent measure, Black's formula (Black, Fisher, “The Pricing of Commodity Contracts,” Journal of Financial Economics 3, 167-179 (1976)) may be used to evaluate the payer and receiver prices

$${SW}_{t}^{p} ( K , T ; M ) ≡ {v}_{1 , t} \cdot Z ( {CDX}_{t} ( M ) , T , K ; ( T - t ) {IV}^{2} ( K ) ) and$$

$${SW}_{t}^{r} ( K , T ; M ) ≡ {v}_{1 , t} \cdot \hat{Z} ( {CDX}_{t} ( M ) , T , K ; ( T - t ) {IV}^{2} ( K ) ) where$$

$$\hat{Z} ( CDX , T , K ; ( T - t ) {IV}^{2} ( K ) ) ≡ Z ( CDX , T , K ; ( T - t ) {IV}^{2} ( K ) ) + K - CDX$$

$$Z ( CDX , T , K ; V ) ≡ CDX \cdot Φ ( d ) - KΦ ( d - \sqrt{V} ) , d = \frac{ln \frac{CDX}{K} + \frac{1}{2} V}{\sqrt{V}}$$

and IV(K) is the percentage implied volatility for strike K and D is the cumulative standard normal distribution function.

We assume that CDXₛ(M) follows a jump diffusion process with stochastic volatility

$$\frac{{dCDX}_{s} ( M )}{{CDX}_{s} ( M )} = - ( {\hat{E}}_{s}^{sc} ( exp ( j ( s ; M ) - 1 ) η ( s ) ) d s + σ ( s ; M ) \cdot d {W}^{sc} ( s ) + ( exp ( j ( s ; M ) - 1 ) d {N}^{sc} ( s ) , s ∈ [ t , T ]$$

where W^{sc}(s) is a multidimensional Brownian motion defined under \hat{Q}_{sc}; σ(s;M) is a diffusion component adapted to W^{sc}(s); N^{sc}(s) is a Cox process with intensity η(s) defined under \hat{Q}_{sc}; j(s;M) is the logarithmic jump size. Then, the realized variance of the logarithmic changes in the CDS index spread, also known as percentage variance, is

V_{M}(t,T)≡∫ₜ^{T}∥σ(s;M)∥²ds+∫ₜ^{T}j²(s;M)dN^{sc}(s)

and the realized variance of the arithmetic changes in the CDS index spread, also known as basis point variance, is

V_{M}^{bp}(t,T)≡∫ₜ^{T}CDXₛ²(M)∥σ(s;M)∥²ds+∫ₜ^{T}CDXₛ²(exp(j(s;M))−1)²dN^{sc}(s)

A “forward credit variance agreement” is an agreement between two parties in which, at time t, counterparty A agrees to pay counterparty B the product of the credit variance realized over [t,T] times the defaultable-PVBP of the outstanding notional that prevails at time T, i.e. V_{M}(t,T)×N(T)v_{1,T}. The price to be paid by counterparty B is denoted as F_{var,M}(t,T) and can be valued as

$${F}_{var , M} ( t , T ) = 2 [ {\sum }_{i : Ki < CDXt ( M )} \frac{{SW}_{t}^{r} ( {K}_{i} , T ; M )}{{K}_{i}^{2}} Δ {K}_{i} + {\sum }_{i : Ki \geq CDXt ( M )} \frac{{SW}_{t}^{p} ( {K}_{i} , T ; M )}{{K}_{i}^{2}} Δ {K}_{i} ]$$

where

$$Δ {K}_{i} = \frac{1}{2} ( {K}_{i + 1} - {K}_{i - 1} )$$

for i≧1, and ΔK₀=(K₁−K₀), ΔK_{Z}=(K_{Z}−K_{Z-1}) where K₀ and K_{Z} are the lowest and highest traded strikes.

A “credit variance swap agreement” is an agreement between two parties in which, at time t, counterparty A agrees to pay counterparty B time T the amount

Var−Swap_{M}(t,T)≡V_{M}(t,T)×N(T)v_{1,T}−P_{var,M}(t,T)

where P_{var,M}(t,T) is a rate fixed at time t and the “credit variance variance swap rate” is the value of P_{var,M}(t,T) such that Var-Swap_{M}(t,T)=0, which can be calculated as

$${P}_{var , M} ( t , T ) = \frac{{F}_{var , M} ( t , T )}{P ( t , T )}$$

The “standardized credit variance swap agreement” is an agreement between two parties in which, at time t, counterparty A agrees to pay counterparty B time T the amount

Var−Swap_{M}*(t,T)≡[V_{M}(t,T)−P_{var,M}*(t,T)]×N(T)v_{1,T}

where P_{var,M}*(t,T) is a rate fixed at time t and the “standardized credit variance swap rate” is the value P_{var,M}*(t,T) such that Var−Swap_{M}*(t,T)=0, which can be calculated as

$${P}_{var , M}^{*} ( t , T ) = \frac{{F}_{var , M} ( t , T )}{{v}_{1 , t}}$$

The Percentage C-VI, C-VI, is defined as

### Continuous Case:

$$C - VI ( t , T , M ) ≡ 100 \times \sqrt{\frac{2}{{v}_{1 , t} ( T - t )} [ {\int }_{0}^{CDXt ( M )} \frac{{SW}_{t}^{r} ( K , T ; M )}{{K}^{2}} d K + {\int }_{CDXt ( M )}^{∞} \frac{{SW}_{t}^{p} ( K , T ; M )}{{K}^{2}} d K ]}$$

### Discrete Case:

$$C - VI ( t , T , M ) ≡ 100 \times \sqrt{\frac{2}{{v}_{1 , t} ( T - t )} [ \begin{matrix}{\sum }_{i : Ki < CDXt ( M )} \frac{{SW}_{t}^{r} ( {K}_{i} , T ; M )}{{K}_{i}^{2}} Δ {K}_{i} + \\ {\sum }_{i : Ki \geq CDXt ( M )} \frac{{SW}_{t}^{p} ( {K}_{i} , T ; M )}{{K}_{i}^{2}} Δ {K}_{i}\end{matrix} ]}$$

Discrete Case with Forward Adjustment:

$$C - VI ( t , T , M ) ≡ 100 \times \sqrt{\frac{1}{( T - t )} [ \frac{2}{{v}_{1 , t}} [ \begin{matrix}{\sum }_{i : Ki < K *} \frac{{SW}_{t}^{r} ( {K}_{i} , T ; M )}{{K}_{i}^{2}} Δ {K}_{i} + \\ {\sum }_{i : Ki \geq K *} \frac{{SW}_{t}^{p} ( {K}_{i} , T ; M )}{{K}_{i}^{2}} Δ {K}_{i}\end{matrix} ] - {( \frac{{CDX}_{t} ( M ) - K *}{K *} )}^{2} ]}$$

where the forward adjustment handles the case in which there is no option struck at the ATM forward spread and K_{*} is the first available strike below the ATM forward spread CDXₜ(M). If the forward spread is not observable at time t, then CDXₜ(M) is the strike at which the difference between the put and call prices is smallest.
More generally, for any constant multiplier CM:

Continuous Case:

$$C - VI ( t , T , M ) ≡ CM \times \sqrt{\frac{2}{{v}_{1 , t} ( T - t )} [ {\int }_{0}^{CDXt ( M )} \frac{{SW}_{t}^{r} ( K , T ; M )}{{K}^{2}} d K + {\int }_{CDXt ( M )}^{∞} \frac{{SW}_{t}^{p} ( K , T ; M )}{{K}^{2}} d K ]}$$

### Discrete Case:

$$C - VI ( t , T , M ) ≡ CM \times \sqrt{\frac{2}{{v}_{1 , t} ( T - t )} [ \begin{matrix}{\sum }_{i : Ki < CDXt ( M )} \frac{{SW}_{t}^{r} ( {K}_{i} , T ; M )}{{K}_{i}^{2}} Δ {K}_{i} + \\ {\sum }_{i : Ki \geq CDXt ( M )} \frac{{SW}_{t}^{p} ( {K}_{i} , T ; M )}{{K}_{i}^{2}} Δ {K}_{i}\end{matrix} ]}$$

Discrete Case with Forward Adjustment:

$$C - VI ( t , T , M ) ≡ CM \times \sqrt{\frac{1}{( T - t )} [ \frac{2}{{v}_{1 , t}} [ \begin{matrix}{\sum }_{i : Ki < K *} \frac{{SW}_{t}^{r} ( {K}_{i} , T ; M )}{{K}_{i}^{2}} Δ {K}_{i} + \\ {\sum }_{i : Ki \geq K *} \frac{{SW}_{t}^{p} ( {K}_{i} , T ; M )}{{K}_{i}^{2}} Δ {K}_{i}\end{matrix} ] - {( \frac{{CDX}_{t} ( M ) - K *}{K *} )}^{2} ]}$$

The above contract designs and index formulas are also extended for options on a forward CDS Index with a later start date than the option (similarly, if futures were traded on the CDS Index, the analogous case would be a future that expires after the option expiry); for example:

$$C - VI ( t , T , {T}_{D} , M ) ≡ 100 \times \sqrt{\frac{1}{( T - t )} [ \begin{matrix}\frac{2}{{v}_{1 , t}} [ \begin{matrix}{\sum }_{i : Ki < K *} \frac{{SW}_{t}^{r} ( {K}_{i} , T , {T}_{D} ; M )}{{K}_{i}^{2}} Δ {K}_{i} + \\ {\sum }_{i : Ki \geq K *} \frac{{SW}_{t}^{p} ( {K}_{i} , T , {T}_{D} ; M )}{{K}_{i}^{2}} Δ {K}_{i}\end{matrix} ] - \\ {( \frac{{CDX}_{t} ( {T}_{D} , M ) - K *}{K *} )}^{2}\end{matrix} ]}$$

where T_{D} denotes a time of maturity of the TD forward underlying the options where T_{D}≧T, and the notation for the forward spread CDXₜ(T_{D},M) has been augmented above to highlight its dependence on the start date, T_{D}, which has been suppressed elsewhere for notational convenience.

A “BP forward credit variance agreement” is an agreement between two parties in which, at time t, counterparty A agrees to pay counterparty B the product of the basis point credit variance realized over [t,T] times the defaultable-PVBP of the outstanding notional that prevails at time T, i.e. V_{M}^{bp}(t,T)×N(T)v_{1,T}. The price to be paid by counterparty B is denoted as F_{var,M}^{bp}(t,T), which may be valued as

$${F}_{var , M}^{bp} ( t , T ) = 2 [ {\sum }_{i : Ki < CDXt ( M )} {SW}_{t}^{r} ( {K}_{i} , T ; M ) Δ {K}_{i} + {\sum }_{i : Ki \geq CDXt ( M )} {SW}_{t}^{p} ( {K}_{i} , T ; M ) Δ {K}_{i} ]$$

where

$$Δ {K}_{i} = \frac{1}{2} ( {K}_{i + 1} - {K}_{i - 1} )$$

for i≧1, and ΔK₀=(K₁−K₀), ΔK_{Z}=(K_{Z}−K_{Z-1}) where K₀ and K_{Z} are the lowest and highest traded strikes.

A “BP credit variance swap agreement” is an agreement between two parties in which, at time t, counterparty A agrees to pay counterparty B time T the amount V_{var,M}^{bp}(t,T)×N(T)v_{1,T}−P_{var,M}^{bp}(t,T) where P_{var,M}^{bp}(t,T) is a rate fixed at time t and the “credit variance variance swap rate” is the value of P_{var,M}^{bp}(t,T) such that V_{var,M}^{bp}(t,T)×N(T)v_{1,T}−P_{var,M}^{bp}(t,T)=0, which can be calculated as

$${P}_{var , M}^{bp} ( t , T ) = \frac{{F}_{var , M}^{bp} ( t , T )}{P ( t , T )}$$

The “standardized BP credit variance swap agreement” is an agreement between two parties in which, at time t, counterparty A agrees to pay counterparty B time T the amount [V_{var,M}^{bp}(t,T)−P_{var,M}*^{bp}(t,T)]×N(T)v_{1,T} where P_{var,M}*^{bp}(t,T) is a rate fixed a time t and the “standardized BP credit variance swap rate” is the value of P_{var,M}*^{bp}(t,T) such that [V_{var,M}^{bp}(t,T)−P_{var,M}*^{bp}(t,T)]×N(T)v_{1,T}=0, which can be calculated as

$${P}_{var , M}^{* bp} ( t , T ) = \frac{{F}_{var , M}^{bp} ( t , T )}{{v}_{1 , t}}$$

The mode-free valuation of the basis point contracts in the three preceding sections do not require ignoring the jump component of the loss-adjusted forward CDS index spread dynamics.

The basis point C-VI, C-VI^{bp}, is defined as

### Continuous Case:

$$C - {VI}^{bp} ( t , T , M ) ≡ 100 \times 100 \times \sqrt{\frac{2}{{v}_{1 , t} ( T - t )} [ {\int }_{0}^{CDXt ( M )} {SW}_{t}^{r} ( K , T ; M ) d K + {\int }_{CDXt ( M )}^{∞} {SW}_{t}^{p} ( K , T ; M ) d K ]}$$

### Discrete Case:

$$C - {VI}^{bp} ( t , T , M ) ≡ 100 \times 100 \times \sqrt{\frac{2}{{v}_{1 , t} ( T - t )} [ \begin{matrix}{\sum }_{i : Ki < CDXt ( M )} {SW}_{t}^{r} ( {K}_{i} , T ; M ) Δ {K}_{i} + \\ {\sum }_{i : Ki \geq CDXt ( M )} {SW}_{t}^{p} ( {K}_{i} , T ; M ) Δ {K}_{i}\end{matrix} ]}$$

Discrete Case with Forward Adjustment:

$$( Equation “ BP\_CVI ” )$$

$$C - {VI}^{bp} ( t , T , M ) ≡ {100}^{2} \times \sqrt{\frac{1}{( T - t )} [ \frac{2}{{v}_{1 , t}} [ \begin{matrix}{\sum }_{i : Ki < K *} {SW}_{t}^{r} ( {K}_{i} , T ; M ) Δ {K}_{i} + \\ {\sum }_{i : Ki \geq K *} {SW}_{t}^{p} ( {K}_{i} , T ; M ) Δ {K}_{i}\end{matrix} ] - {( {CDX}_{t} ( M ) - {K}_{*} )}^{2} ]}$$

where the forward adjustment handles the case in which there is no option struck at the ATM forward spread and K_{*} is the first available strike below the ATM forward spread CDXₜ(M). If the forward spread is not observable at time t, then CDXₜ(M) is the strike at which the difference between the put and call prices is smallest.
More generally, for any constant multiplier CM:

### Continuous Case:

$$C - {VI}^{bp} ( t , T , M ) ≡ CM \times \sqrt{\frac{2}{{v}_{1 , t} ( T - t )} [ {\int }_{0}^{CDXt ( M )} {SW}_{t}^{r} ( K , T ; M ) d K + {\int }_{CDXt ( M )}^{∞} {SW}_{t}^{p} ( K , T ; M ) d K ]}$$

### Discrete Case:

$$C - {VI}^{bp} ( t , T , M ) ≡ CM \times \sqrt{\frac{2}{{v}_{1 , t} ( T - t )} [ \begin{matrix}{\sum }_{i : Ki < CDXt ( M )} {SW}_{t}^{r} ( K , T ; M ) Δ {K}_{i} + \\ {\sum }_{i : Ki \geq CDXt ( M )} {SW}_{t}^{p} ( K , T ; M ) Δ {K}_{i}\end{matrix} ]}$$

Discrete Case with Forward Adjustment:

$$C - {VI}^{bp} ( t , T , M ) ≡ CM \times \sqrt{\frac{1}{( T - t )} [ \frac{2}{{v}_{1 , t}} [ \begin{matrix}{\sum }_{i : Ki < K *} {SW}_{t}^{r} ( {K}_{i} , T ; M ) Δ {K}_{i} + \\ {\sum }_{i : Ki \geq K *} {SW}_{t}^{p} ( {K}_{i} , T ; M ) Δ {K}_{i}\end{matrix} ] - {( {CDX}_{t} ( M ) - {K}_{*} )}^{2} ]}$$

The above contract designs and index formulas are also extended for options on a forward CDS Index with a later start date than the option (similarly, if futures were traded on the CDS Index, the analogous case would be a future that expires after the option expiry); for example:

$$C - {VI}^{bp} ( t , T , {T}_{D} , M ) ≡ {100}^{2} \times \sqrt{\frac{1}{( T - t )} [ \frac{2}{{v}_{1 , t}} [ \begin{matrix}{\sum }_{i : Ki < K *} {SW}_{t}^{r} ( {K}_{i} , T , {T}_{D} ; M ) Δ {K}_{i} + \\ {\sum }_{i : Ki \geq K *} {SW}_{t}^{p} ( {K}_{i} , T , {T}_{D} ; M ) Δ {K}_{i}\end{matrix} ] - {( {CDX}_{t} ( {T}_{D} , M ) - {K}_{*} )}^{2} ]}$$

where T_{D} denotes a time of maturity of the TD forward underlying the options where T_{D}≧T, and the notation for the forward spread CDXₜ(T_{D},M) has been augmented above to highlight its dependence on the start date, T_{D}, which has been suppressed elsewhere for notational convenience.

The mathematical exposition and formulas given above for Credit Volatility Indexes employ prices of European-style options on forward spreads. However, options with other exercise styles or options with other underlying spreads, such as futures spreads, may also be used directly in the above formulas if it is determined that the prices of such options are not materially different from equivalent prices of European-style options on forward spreads. For example, prices of out-of-the-money American-style options on a futures spread are likely to not be materially different from otherwise-equivalent European-style options on a forward spread, as one may conclude from the work of Flesaker, B. 1993, “Testing the Heath-Jarrow-Morton/Ho-Lee Model of Interest Rate Contingent Claims Pricing” Journal of Financial and Quantitative Analysis 28: pp. 483-495.

In the case that prices of available options that are not European-style on CDS index forward spreads may be materially different from those of European-style options on CDS index forward spreads, then a price adjustment may be made. For example, one may one may specify a market model [e.g. Brace, Gatarek and Musiela (1997), Jamshidian (1997), Miltersen, Sandmann and Sondermann (1997)] for the dynamics of the CDS index forward spreads, which leads to (i) an analytical solution for the European-style options on forwards based on Black's (1976) formula, and (ii) a numerical solution for the American-style options on futures. Then, one can calibrate an American Black's volatility for each future strike and exactly match the option price in (ii) to the market price for each strike, and use these calibrated American Black's volatilities to calculate the value of the European-style options in (i), which are then used to feed the index. This calibration procedure is a generalization of that implemented by Broadie, Chernov and Johannes (2007) in the equity case, and in regard of at-the-money American options. The forward spread is estimated through the value of the future spread, and if the future spread is not available, one can use the future strike at which the difference between the American put and call prices is smallest.

The methodology for computing Percentage and Basis Point C-VIs for forward CDS index spread volatility based on CDS index options can also be used to calculate Percentage and Basis Point C-VIs for forward single-name CDS spread volatility based on CDS options, simply by setting n=1 throughout the exposition.

For CDS index option markets that trade in cycles based on standardized roll dates (e.g. quarterly rolls in March, June, September, December), two or more options with varying maturities may be used in combination to calculate an index with a maturity corresponding to any maturity in between the shortest and longest maturities used.

In the case where CDS index options trade with maturity cycles, as a first non-limiting example, the index may be calculated with the nearest and next roll dates using a “sandwich combination” such that a volatility index with an m month horizon is calculated as

$${I}_{t} ≡ \sqrt{\frac{1}{( m / 12 )} [ {x}_{t} {V}_{t} ( {T}_{i} ) + ( 1 - {x}_{t} ) {V}_{t} ( {T}_{i + 1} ) ]} , t ∈ [ {T}_{i - 1} , {T}_{i} ]$$

where Tᵢ−Tᵢ₋₁=Tᵢ₊₁−T=m×d and Tᵢ₊₁−Tᵢ₋₁=2m×d; d is the number of days in a month; Vₜ(Tᵢ) is equal to the square of PCT_CVI for the Percentage Credit Volatility Index case and the square of BP_CVI for the Basis Point Credit Volatility Index case; and xₜ is the weight such that

$${x}_{t} \frac{{T}_{i} - t}{12 d} + ( 1 - {x}_{t} ) \frac{{T}_{i + 1} - t}{12 d} = \frac{m}{12} , t ∈ [ {T}_{i - 1} , {T}_{i} ]$$

which leads to the expression

$${I}_{t} ≡ \sqrt{\frac{1}{( m / 12 )} [ ( \frac{{T}_{i + 1} - t}{m \times d} - 1 ) {V}_{t} ( {T}_{i} ) + ( 2 - \frac{{T}_{i + 1} - t}{m \times d} ) {V}_{t} ( {T}_{i + 1} )} , \\ t ∈ [ {T}_{i - 1} , {T}_{i} ]$$

In the case where CDS Index options trade with maturity cycles, as a second non-limiting example, the volatility index may be calculated based on the skew of a particular option contract with a shrinking time to maturity. For example, if the index is based on options expiring in three months on a 5-year index, the index on the first day would reflect expected volatility over the next three months, on the next day would reflect expected volatility over the next three months minus one day, and so on, until the index naturally expires at option expiry in three months.

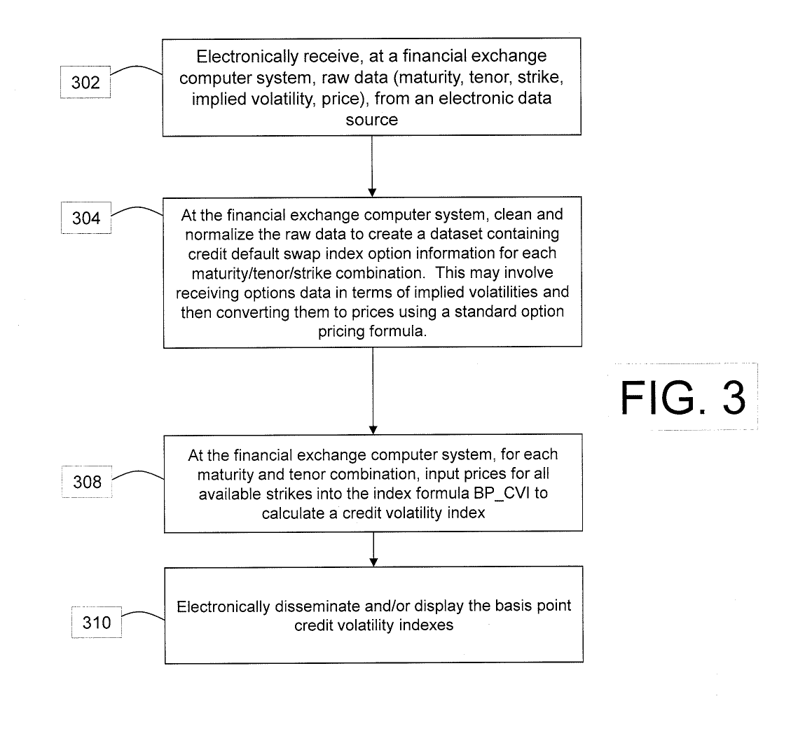

FIG. 3, is a flow diagram that outlines an embodiment of the steps for calculating and disseminating a basis point C-VI according to the present invention. At step 302, data is received electronically from an electronic data source. Included in the received data is data regarding the CDS index options. At step 304, the data is cleaned and normalized, according to known techniques. At step 308, the prices for each maturity and tenor combination for all available strikes are inputted into equation BP_CVI, shown above, to calculate a basis point C-VI.

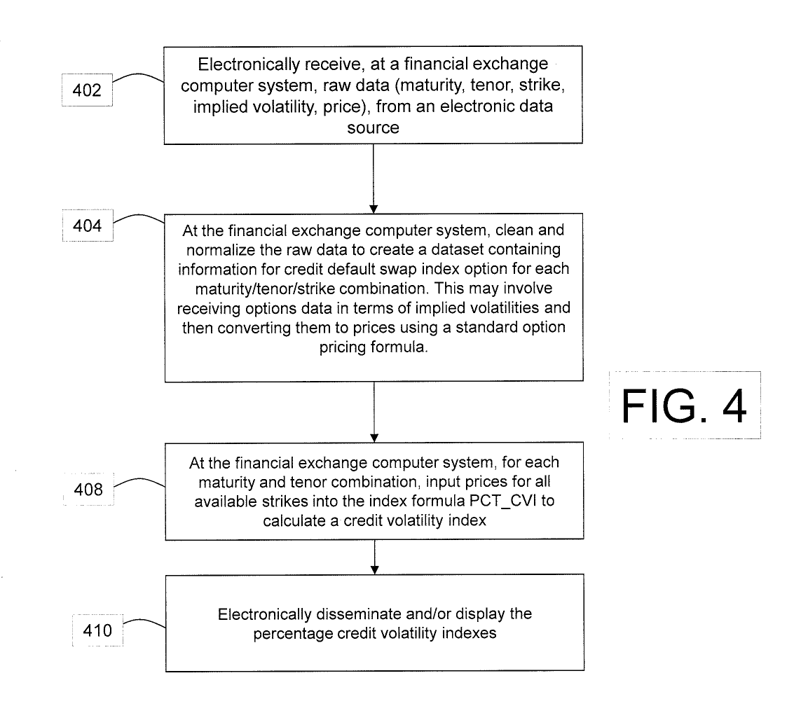

FIG. 4, is a flow diagram that outlines an embodiment of the steps for calculating and disseminating a percentage C-VI according to the present invention. At step 402, data is received electronically from an electronic data source. Included in the received data is data regarding the CDS index options. At step 404, the data is cleaned and normalized, according to known techniques. At step 408, the prices for each maturity and tenor combination for all available strikes are inputted into equation PCT_CVI, shown above, to calculate a percentage credit volatility index.

The steps shown in FIGS. 3 and 4 can be performed using the systems illustrated in FIGS. 1, 2, and 5.

### Implementation Examples

The following is a non-limiting example of how the methodologies of the present invention can be used to construct the Basis Point C-VI and the Percentage C-VI. As noted above the actual calculation and dissemination of the Basis Point C-VI and the Percentage C-VI are performed by the calculation and dissemination system, an example of which is illustrated in FIGS. 3 and 4.

The present example utilizes data reflecting hypothetical market prices. The data provided are implied volatilities expressed in percentage terms, and relate to CDS index options maturing in two months and tenor equal to five years. The data for this example is provided below in table 1:

TABLE 1

| | | Black's prices | |
|---|---|---|---|
| Strike | Percentage | Receiver | Payer |
| (in basis points) | Implied Vol | Swaption (\hat{Z}) | Swaption Z |
| 80 | 48.00 | 6.7430 · 10⁻⁵ | 2.5674 · 10⁻³ |
| 85 | 47.50 | 0.1279 · 10⁻³ | 2.1279 · 10⁻³ |
| 90 | 49.50 | 0.2512 · 10⁻³ | 1.7512 · 10⁻³ |
| 95 | 50.50 | 0.4151 · 10⁻³ | 1.4154 · 10⁻³ |
| 100 | 54.00 | 0.6714 · 10⁻³ | 1.1714 · 10⁻³ |
| 105 (ATM) | 55.00 | 0.9385 · 10⁻³ | 0.9385 · 10⁻³ |
| 110 | 56.00 | 1.2484 · 10⁻³ | 0.7484 · 10⁻³ |
| 115 | 57.50 | 1.6035 · 10⁻³ | 0.6035 · 10⁻³ |
| 120 | 59.50 | 1.9967 · 10⁻³ | 0.4967 · 10⁻³ |
| 125 | 61.50 | 2.4130 · 10⁻³ | 0.4130 · 10⁻³ |
| 130 | 62.50 | 2.8339 · 10⁻³ | 0.3339 · 10⁻³ |
| 135 | 63.50 | 3.2710 · 10⁻³ | 0.2710 · 10⁻³ |
| 140 | 65.50 | 3.7319 · 10⁻³ | 0.2319 · 10⁻³ |
| 145 | 66.50 | 4.1910 · 10⁻³ | 0.1910 · 10⁻³ |

The first two columns of Table 1, as shown above, report strike rates, K, and percentage implied volatilities for each strike rate, IV(K).

According to an embodiment of the present invention, the Basis Point C-VI and Percentage C-VI are calculated by first, plugging the “skew” IV(K) into the Black's formula, and then, replacing the Black's formula into the formulas shown above for calculating the Basis Point C-VI and Percentage C-VI, i.e., equations BP_CVI and PCT_CVI. Accordingly:

$$C - VI ( t , T , M ) = 100 \times \sqrt{\frac{2}{T - t} [ \begin{matrix}{\sum }_{i ; {K}_{i} < CDXt} \frac{\hat{Z} ( {CDX}_{t} , T , {K}_{i} ; ( T - t ) {IV}^{2} ( {K}_{i} ) )}{{K}_{i}^{2}} Δ {K}_{i +} \\ {\sum }_{i ; {K}_{i} \geq {CDX}_{i}} \frac{Z ( {CDX}_{t} , T , {K}_{i} ; ( T - t ) {IV}^{2} ( {K}_{i} ) )}{{K}_{i}^{2}} Δ {K}_{i}\end{matrix} ]} ( Equation “ PCT\_CVI \_IV ” )$$

$$and$$

$$C - {VI}^{bp} ( t , T , M ) = {100}^{2} \times \sqrt{\frac{2}{T - t} [ \begin{matrix}{\sum }_{i ; {K}_{i} < {CDX}_{i}} \hat{Z} ( {CDX}_{t} , T , {K}_{t} ; ( T - t ) {IV}^{2} ( {K}_{i} ) ) Δ {K}_{i +} \\ {\sum }_{i ; {K}_{i} \geq CDXt} Z ( {CDX}_{t} , T , {K}_{i} ; ( T - t ) {IV}^{2} ( {K}_{i} ) ) Δ {K}_{i}\end{matrix} ]} ( Equation “ BP\_CVI \_IV ” )$$

$$where$$

$$\hat{Z} ( CDX , T , {K}_{i} ; ( T - t ) {IV}^{2} ( {K}_{i} ) ) = Z ( CDX , T , {K}_{i} ; ( T - t ) {IV}^{2} ( {K}_{i} ) ) + K - CDX \\ Z ( CDX , T , K ; V ) = CDX \cdot Φ ( d ) - K Φ ( d - \sqrt{V} ) , d = \frac{ln \frac{CDX}{K} + \frac{1}{2} V}{\sqrt{V}}$$

where Φ denotes the cumulative standard normal distribution.

According to the present example, the percentage implied volatilities, IV(K), are utilized to obtain values for \hat{Z} and Z. The third and fourth columns of Table 1, as shown above, provide CDS index option prices re-normalized by the defaultable PVBP, i.e., the values of \hat{Z} and Z, for each strike rate.

Table 2, as shown below, provides information regarding the present examples calculation of the Basis Point C-VI and Percentage C-VI, according to equations BP_CVI_IV and PCT_CVI_IV, respectively.

TABLE 2

| | | | Weights | | Contributions to Strikes | |
|---|---|---|---|---|---|---|
| Strike | Swaption | | Basis Point | Percentage | Basis Point | Percentage |
| (in basis points) | Type | Price | ΔK₂ | ΔK₁/K₁² | Contribution | Contribution |
| 80 | Receiver | 6.7430 · 10⁻⁵ | 0.0005 | 7.8125 | 3.3715 · 10⁻⁸ | 0.5268 · 10⁻³ |
| 85 | Receiver | 0.1279 · 10⁻³ | 0.0005 | 6.9204 | 6.3951 · 10⁻⁸ | 0.8851 · 10⁻³ |
| 90 | Receiver | 0.2512 · 10⁻³ | 0.0005 | 6.1728 | 1.2563 · 10⁻⁷ | 1.5510 · 10⁻³ |
| 95 | Receiver | 0.4151 · 10⁻³ | 0.0005 | 5.5401 | 2.0774 · 10⁻⁷ | 2.3018 · 10⁻³ |
| 10 | Receiver | 0.6714 · 10⁻³ | 0.0005 | 5.0000 | 3.3574 · 10⁻⁷ | 3.3574 · 10⁻³ |
| 105 | ATM | 0.9385 · 10⁻³ | 0.0005 | 4.5351 | 4.6929 · 10⁻⁷ | 4.2566 · 10⁻³ |
| 110 | Payer | 0.7484 · 10⁻³ | 0.0005 | 4.1322 | 3.7421 · 10⁻⁷ | 3.0926 · 10⁻³ |
| 115 | Payer | 0.6035 · 10⁻³ | 0.0005 | 3.7807 | 3.0179 · 10⁻⁷ | 2.2820 · 10⁻³ |
| 120 | Payer | 0.4967 · 10⁻³ | 0.0005 | 3.4722 | 2.4837 · 10⁻⁷ | 1.7248 · 10⁻³ |
| 125 | Payer | 0.4130 · 10⁻³ | 0.0005 | 3.2000 | 2.0651 · 10⁻⁷ | 1.3216 · 10⁻³ |
| 130 | Payer | 0.3339 · 10⁻³ | 0.0005 | 2.9585 | 1.6695 · 10⁻⁷ | 0.9879 · 10⁻³ |
| 135 | Payer | 0.2710 · 10⁻³ | 0.0005 | 2.7434 | 1.3551 · 10⁻⁷ | 0.7435 · 10⁻³ |
| 140 | Payer | 0.2319 · 10⁻³ | 0.0005 | 2.5510 | 1.1597 · 10⁻⁷ | 0.5917 · 10⁻³ |
| 145 | Payer | 0.1910 · 10⁻³ | 0.0005 | 2.3781 | 9.5530 · 10⁻⁸ | 0.4543 · 10⁻³ |
| | | | | SUMS | 2.8809 · 10⁻⁶ | 2.4077 · 10⁻² |

The second column of Table 2 displays the type of out-of-the money CDS index option entering in the calculations of the embodiments of the C-VI. The third column has the price normalized by the risky PVBP corresponding to the used CDS index options; the fourth and fifth columns report the weights each Black's price bears towards the final computation of the index, before the final rescaling of

$$\frac{2}{T - t} ;$$

and finally, the sixth and seventh columns report each out-of-the money CDS index option price corrected by the appropriate weight. Each price in the third column is multiplied by the corresponding weight in the fourth column, for the “Basis Point Contribution,” and each price in the third column is multiplied by the corresponding weight in the fifth column, for the “Percentage Contribution.”

Thus, according to the data provided in this example, embodiments of the Basis Point C-VI and Percentage C-VI are calculated, respectively, as follows:

$$C - VI = 100 \times \sqrt{\frac{2}{( 2 / 12 )} \times 2.4077 \cdot {10}^{- 2}} = 53.7524 , and$$

$$C - {VI}^{bp} = {100}^{2} \times \sqrt{\frac{2}{( 2 / 12 )} \times 2.8809 \cdot {10}^{- 6}} = 58.7975 .$$

For purposes of comparison, the at-the-money implied basis point and percentage volatilities are IV^{BP} (CDX)=57.75 bps and IV(CDX)=55%.

In this non-limiting example, the basis point index is rescaled by 100², to mimic the market practice to express basis point implied volatility as the product of rates times log-volatility, where both rates and log-volatility are multiplied by 100.

According to embodiments of the present invention, indices calculated according to the embodiments of the present invention may serve as the underlying asset for derivative contracts, such as options and futures contracts. More particularly, according to an embodiment of the present invention, a C-VI may serve as the underlying reference for derivative contracts designed for trading the volatility of forward CDS index spreads of various indexes and tenors. In particular, futures and options contracts with varying maturities based the index may be traded OTC and/or listed on exchanges.

Derivative instruments based on the credit default swap index option volatility index disclosed above may be created as standardized, exchange-traded contracts, as opposed to over-the-counter contracts. Once the credit default swap index option volatility index (C-VI) based on CDS index options is calculated, the index may be accessed for use in creating a derivative contract, and the derivative contract may be assigned a unique symbol. Generally, the C-VI derivative contract may be assigned any unique symbol that serves as a standard identifier for the type of standardized C-VI derivative contract. Information associated with the C-VI and/or the C-VI derivative contract may be transmitted for display, such as transmitting information to list the C-VI index and/or the C-VI derivative on a trading platform. Examples of the types of information that may be transmitted for display include a settlement price of a C-VI derivative, a bid or offer associated with a C-VI derivative, a value of a C-VI index, and/or a value of an underlying CDS index option that a C-VI is associated with.

Generally, a C-VI derivative contract may be listed on an electronic platform, an open outcry platform, a hybrid environment that combines the electronic platform and open outcry platform, or any other type of platform known in the art. One example of a hybrid exchange environment is disclosed in U.S. Pat. No. 7,613,650, filed Apr. 24, 2003, the entirety of which is herein incorporated by reference. Additionally, a trading platform such as an exchange may transmit C-VI derivative contract quotes of liquidity providers over dissemination networks to other market participants. Liquidity providers may include Designated Primary Market Makers (“DPM”), market makers, locals, specialists, trading privilege holders, registered traders, members, or any other entity that may provide a trading platform with a quote for a variance derivative. Dissemination Networks may include networks such as the Options Price Reporting Authority (“OPRA”), the CBOE Futures Network, an Internet website or email alerts via email communication networks. Market participants may include liquidity providers, brokerage firms, normal investors, or any other entity that subscribes to a dissemination network.

The trading platform may execute buy and sell orders for the C-VI derivative and may repeat the steps of calculating the C-VI of the underlying CDS index options, accessing the C-VI index, transmitting information for the C-VI index and/or the C-VI derivative for display (list the C-VI and/or C-VI derivative on a trading platform), disseminating the C-VI and/or the C-VI derivative over a dissemination network, and executing buy and sell orders for the C-VI derivative until the C-VI derivative contract is settled.

In some implementations, C-VI derivative contracts may be traded through an exchange-operated parimutuel auction and cash-settled based on the C-VI index of log returns of the underlying equity. An electronic parimutuel, or Dutch, auction system conducts periodic auctions, with all contracts that settle in-the-money funded by the premiums collected for those that settle out-of-the-money.

As mentioned, in a parimutuel auction, all the contracts that settle in-the-money are funded by those that settle out-of-the-money. Thus, the net exposure of the system is zero once the auction process is completed, and there is no accumulation of open interest over time. Additionally, the pricing of contracts in a parimutuel auction depends on relative demand; the more popular the strike, the greater its value. In other words, a parimutuel action does not depend on market makers to set a price; instead the price is continuously adjusted to reflect the stream of orders coming into the auction. Typically, as each order enters the system, it affects not only the price of the sought-after strike, but also affects all the other strikes available in that auction. In such a scenario, as the price rises for the more sought-after strikes, the system adjusts the prices downward for the less popular strikes. Further, the process does not require the matching of specific buy orders against specific sell orders, as in many traditional markets. Instead, all buy and sell orders enter a single pool of liquidity, and each order can provide liquidity for other orders at different strike prices and the liquidity is maintained such that system exposure remains zero. This format maximizes liquidity, a key feature when there is no tradable underlying instrument.

The following characteristics of futures contracts illustrate one embodiment of a futures contract having an index of the present invention as an underlying asset. The characteristics are not meant to limit the present invention, but rather to set forth common characteristics of futures:

Contract Size: The notional amount of one unit of the contract may be defined as a multiple of the index level, which may depend on the currency of the underlying index. When traded OTC, the multiplier may be negotiated between the parties involved on a trade-by-trade basis.

Contract Months: An exchange may list contracts with a pre-determined sequence of maturity dates, e.g. the 3rd Friday of each of the next 6 months. Similarly, OTC dealers may make markets in a pre-determined sequence of maturity dates but may also make markets for contracts that mature on other dates on a trade-by-trade basis.

Quotation & Minimum Price Intervals: Futures based on the index may be quoted in points and decimals or fractions that represent some notional amount per contract and there may be a minimum increment by which the pricing of the contracts may vary, both of which may depend on the currency of the underlying index. The OTC market may adopt different conventions for quoting and minimum ticks.

Last Trading Date: For each contract, a last trading date will be specified.

Final Settlement Date: For each contract, a final settlement date will be specified.

Final Settlement Value: The final settlement value shall be based on the level of the index computed at a pre-specified time on the settlement date.

Delivery: Settlement of futures based on the index will take the form of a delivery of the cash settlement amount and a payment date will be specified in relation to the final settlement date.

Additional Specifications when Exchange Traded: When traded on an exchange, trading platform, margin requirements, trading hours, order crossing rules, block trading rules, reporting rules, and other details may be specified.

The following characteristics of options contracts illustrate one embodiment of an options contract having an index of the present invention as an underlying asset. The characteristics are not meant to limit the present invention, but rather to set forth common characteristics of options:

Contract Size: The notional amount of one unit of the contract may be defined as a multiple of the index level, which may depend on the currency of the underlying index. When traded OTC, the multiplier may be negotiated between the parties involved on a trade-by-trade basis.

Contract Months: An exchange may list contracts with a pre-determined sequence of expiration dates, e.g. the 3rd Friday of each of the next 6 months. Similarly, OTC dealers may make markets in a pre-determined sequence of maturity dates but may also make markets for contracts that expire on other dates on a trade-by-trade basis.

Strike Prices: For each currency, strike prices that are in-, at-, and out-of the money may be listed by an exchange or quoted by OTC dealers and new strike prices may be traded as swap rates increase and decrease. An exchange or the OTC dealer community may fix a minimum increment between strike prices, depending on the currency of the underlying index.

Quotation & Minimum Price Intervals: Options based on the index may be quoted in points and decimals or fractions that represent some notional amount per contract and there may be a minimum increment by which the pricing of the contracts may vary, both of which may depend on the currency of the underlying index. The OTC Market may adopt different conventions for quoting and minimum ticks.

Exercise Style: Options written on the C-VI are likely to be, but not limited to, European style. It is envisioned that American style contracts could also have an index of the present invention as an underlying asset

Expiration Date: For each contract, an expiration date will be specified.

Last Trading Date: For each contract, a last trading date will be specified.

Settlement of Exercise: The final settlement value shall be based on the level of the index computed at a pre-specified time on the settlement date. The cash settlement amount will be the difference between the index level and the strike price, possibly adjusted by some multiplier, and a payment date will be specified in relation to the expiration date.

Additional Specifications when Exchange Traded: When traded on an exchange, trading platform, margin requirements, trading hours, reporting rules, and other details may be specified.

According to other embodiments of the present invention, other financial products that track or reference the indices of the present invention may be created. Such products include, but are not limited to, Exchange Traded Funds and Exchange Traded Notes listed on exchanges and structured products sold by financial institutions.

Credit volatility indexes and derivative instruments based there on have been disclosed. An advantage of derivatives based on the credit volatility indexes disclosed herein is the ability to provide a hedge against options or other derivatives that are subject to credit volatility risk. It is intended that the foregoing detailed description be regarded as illustrative rather than limiting, and that it be understood that it is the following claims, including all equivalents, that are intended to define the spirit and scope of this invention.

What is claimed is:

1. A computer system for calculating a credit volatility index comprising:
memory configured to store at least one program; and
at least one processor communicatively coupled to the memory, in which the at least one program, when executed by the at least one processor, causes the at least one processor to:
receive data regarding options on credit default swap index derivatives;
calculate, using the data regarding options on credit default swap index derivatives, the credit volatility index; and
transmit data regarding the credit volatility index.

2. The computer system of claim 1, wherein the data regarding options on credit default swap index derivatives includes data regarding prices of options on credit default swap index derivatives.

3. The computer system of claim 2, wherein the data regarding prices of options on credit default swap index derivatives includes data regarding prices of European style options on credit default swap index forwards.

4. The computer system of claim 2, wherein the data regarding prices of options on credit default swap index derivatives includes data regarding prices of options that are not European style options on credit default swap index forwards.

5. The computer system of claim 4, wherein, when the data regarding prices of options on credit default swap derivatives includes data regarding prices of options that are not European-style options on credit default swap index forwards, converting the data regarding prices of options that are not European-style options on credit default swap index forwards to data regarding prices of European style options on credit default swap index forwards.

6. The computer systems of claim 1, wherein calculating the credit volatility index includes valuing a basket of options on the credit default swap derivatives required for model-independent pricing of a variance swap contract on the credit default swap derivatives.

7. The computer systems of claims 3, 4, 5, or 6, wherein the credit volatility index is calculated at time t according to the equation:
$$C - VI ( t , T , {T}_{D} , M ) ≡ 100 \times \sqrt{\frac{1}{( T - t )} [ \begin{matrix}\frac{2}{{v}_{1 , t}} [ \begin{matrix}{\sum }_{i : Ki < {K}_{*}} \frac{{SW}_{t}^{r} ( {K}_{i} , T , {T}_{D} ; M )}{{K}_{i}^{2}} Δ {K}_{i} + \\ {\sum }_{i : {K}_{i} \geq {K}_{*}} \frac{{SW}_{t}^{p} ( {K}_{i} , T , {T}_{D} ; M )}{{K}_{i}^{2}} Δ {K}_{i}\end{matrix} ] - \\ {( \frac{{CDX}_{t} ( {T}_{D} , M ) - {K}_{*}}{{K}_{*}} )}^{2}\end{matrix} ]}$$
wherein:
t denotes a time at which the credit volatility index is calculated;
T denotes a time of expiry of options on credit default swap index derivatives;
T_{D} denotes a time of maturity of credit default swap index derivatives underlying the options where T_{D}≧T;
M denotes a time of expiry of credits default swap indexes;
Z+1 denotes a total number of options used in the index calculation;
K₀ denotes the lowest strike of the Z+1 options;
Kᵢ denotes the i^{th} highest strike of the Z+1 options;
K_{Z} denotes the highest strike of the Z+1 options;
$$Δ {K}_{i} = \frac{1}{2} ( {K}_{i + 1} - {K}_{i - 1} )$$
for i≧1, and ΔK₀=(K₁−K₀), ΔK_{Z}=(K_{Z}−K_{Z-1});
if the price is observable at time t, then CDXₜ(T_{D},M) is a price at time t of a credit default swap index derivative underlying the put and call options, expiring at T_{D} with an underlying credit default swap index maturing at M;
if the price is not observable at time t, then CDXₜ(T_{D},M) is the spread at which the difference between the put and call prices is smallest;
if there exists an option struck at CDXₜ(T_{D},M), then K_{*} equals CDXₜ(T_{D},M);
if there does not exist an option struck at CDXₜ(T_{D},M), then K_{*} is the first available strike below CDXₜ(T_{D},M);
v_{1,t} is a price value of a basis point at time t, adjusted for default risk, of the credit default swap index premium payments;
SWₜ^{r}(Kᵢ,T,T_{D};M) is a price at time t of a receiver option, struck at Kᵢ, expiring at T, and having an underlying credit default swap index derivative expiring at T_{D} with an underlying credit default swap index maturing at M;
SWₜ^{p}(Kᵢ,T,T_{D};M) is a price at time t of a payer option, struck at Kᵢ, expiring at T, and having an underlying credit default swap index derivative expiring at T_{D} with an underlying credit default swap index maturing at M; and
C-VI(t,T,T_{D},M) is the value of the credit volatility index at time t calculated based on options expiring at T on credit default swap index derivatives expiring at T_{D} with an underlying credit default swap index maturing at M.

8. The computer systems of claims 3, 4, 5, or 6, wherein the credit volatility index is calculated at time t according to the equation:
$$C - {VI}^{bj} ( t , T , {T}_{D} , M ) ≡ {100}^{2} \times \sqrt{\frac{1}{( T - t )} [ \begin{matrix}\frac{2}{{v}_{1 , t}} [ \begin{matrix}{\sum }_{i : {K}_{i} < {K}_{*}} {SW}_{t}^{r} ( {K}_{i} , T , {T}_{D} ; M ) Δ {K}_{i} + \\ {\sum }_{i : {K}_{i} \geq {K}_{*}} {SW}_{t}^{p} ( {K}_{i} , T , {T}_{D} ; M ) Δ {K}_{i}\end{matrix} ] - \\ {( {CDX}_{t} ( {T}_{D} , M ) - {K}_{*} )}^{2}\end{matrix} ]}$$
wherein:
t denotes a time at which the credit volatility index is calculated;
T denotes a time of expiry of options on credit default swap index derivatives;
T_{D} denotes a time of maturity of credit default swap index derivatives underlying the options where T_{D}≧T;
M denotes a time of expiry of credits default swap indexes;
Z+1 denotes a total number of options used in the index calculation;
K₀ denotes the lowest strike of the Z+1 options;
Kᵢ denotes the i^{th} highest strike of the Z+1 options;
K_{Z} denotes the highest strike of the Z+1 options;
$$Δ {K}_{i} = \frac{1}{2} ( {K}_{i + 1} - {K}_{i - 1} )$$
for i≧1, and ΔK₀=(K₁−K₀), ΔK_{Z}=(K_{Z}−K_{Z-1});
if the price is observable at time t, then CDXₜ(T_{D},M) is a price at time t of a credit default swap index derivative underlying the put and call options, expiring at T_{D} with an underlying credit default swap index maturing at M;
if the price is not observable at time t, then CDXₜ(T_{D},M) is the spread at which the difference between the put and call prices is smallest;
if there exists an option struck at CDXₜ(T_{D},M), then K_{*} equals CDXₜ(T_{D},M);
if there does not exist an option struck at CDXₜ(T_{D},M), then K_{*} is the first available strike below CDXₜ(T_{D},M);
v_{1,t} is a price value of a basis point at time t, adjusted for default risk, of the credit default swap index premium payments;
SWₜ^{r}(Kᵢ,T,T_{D};M) is a price at time t of a receiver option, struck at Kᵢ, expiring at T, and having an underlying credit default swap index derivative expiring at T_{D} with an underlying credit default swap index maturing at M;
SWₜ^{p}(Kᵢ,T,T_{D};M) is a price at time t of a payer option, struck at Kᵢ, expiring at T, and having an underlying credit default swap index derivative expiring at T_{D} with an underlying credit default swap index maturing at M; and
C-VI^{bp}(t,T,T_{D},M) is the value of the credit volatility index at time t calculated based on options expiring at T on credit default swap index derivatives expiring at T_{D} with an underlying credit default swap index maturing at M.

9. The computer system of claim 1, wherein the at least one processor is further caused to:
create a standardized exchange-traded derivative instrument based on the credit volatility index; and
transmit data regarding the standardized exchange-traded derivative.

10. The computer system of claim 9, wherein transmitting data regarding the standardized exchange-traded derivative instrument includes transmitting data regarding one or more of a settlement price, a bid price, an offer price, or a trade price of the standardized exchange-traded derivative instrument.

11. A non-transitory computer readable storage medium having computer-executable instructions recorded thereon that, when executed on a computer, configure the computer to perform a method to calculate a credit volatility index, the method comprising:
receiving data regarding options on credit default swap index derivatives;
calculating, using the data regarding options on credit default swap index derivatives, the credit volatility index; and
transmitting data regarding the credit volatility index.

12. The non-transitory computer readable storage medium of claim 11, wherein the data regarding options on credit default swap index derivatives includes data regarding prices of options on credit default swap index derivatives.

13. The non-transitory computer readable storage medium of claim 12, wherein the data regarding prices of options on credit default swap index derivatives includes data regarding prices of European style options on credit default swap index forwards.

14. The non-transitory computer readable storage medium of claim 12, wherein the data regarding prices of options on credit default swap index derivatives includes data regarding prices of options that are not European style options on credit default swap index forwards.

15. The non-transitory computer readable storage medium of claim 14, wherein, when the data regarding prices of options on credit default swap index derivatives includes data regarding prices of options that are not European-style options on credit default swap index forwards, converting the data regarding prices of options that are not European-style options on credit default swap index forwards to data regarding prices of European style options on credit default swap index forwards.

16. The non-transitory computer readable storage medium of claim 11, wherein calculating the credit volatility index includes valuing a basket of options on the credit default swap index derivatives required for model-independent pricing of a variance swap contract on the credit default swap index derivatives.

17. The non-transitory computer readable storage medium of claims 13, 14, 15 or 16, wherein the credit volatility index is calculated at time t according to the equation:
$$C - VI ( t , T , {T}_{D} , M ) ≡ 100 \times \sqrt{\frac{1}{( T - t )} [ \begin{matrix}\frac{2}{{v}_{1 , t}} [ \begin{matrix}{\sum }_{i : Ki < {K}_{*}} \frac{{SW}_{t}^{r} ( {K}_{i} , T , {T}_{D} ; M )}{{K}_{i}^{2}} Δ {K}_{i} + \\ {\sum }_{i : {K}_{i} \geq {K}_{*}} \frac{{SW}_{t}^{p} ( {K}_{i} , T , {T}_{D} ; M )}{{K}_{i}^{2}} Δ {K}_{i}\end{matrix} ] - \\ {( \frac{{CDX}_{t} ( {T}_{D} , M ) - {K}_{*}}{{K}_{*}} )}^{2}\end{matrix} ]}$$
wherein:
t denotes a time at which the credit volatility index is calculated;
T denotes a time of expiry of options on credit default swap index derivatives;
T_{D} denotes a time of maturity of credit default swap index derivatives underlying the options where T_{D}≧T;
M denotes a time of expiry of credits default swap indexes;
Z+1 denotes a total number of options used in the index calculation;
K₀ denotes the lowest strike of the Z+1 options;
Kᵢ denotes the i^{th} highest strike of the Z+1 options;
K_{Z} denotes the highest strike of the Z+1 options;
$$Δ {K}_{i} = \frac{1}{2} ( {K}_{i + 1} - {K}_{i - 1} )$$
for i≧1, and ΔK₀=(K₁−K₀), ΔK_{Z}=(K_{Z}−K_{Z-1});
if the price is observable at time t, then CDXₜ(T_{D},M) is a price at time t of a credit default swap index derivative underlying the put and call options, expiring at T_{D} with an underlying credit default swap index maturing at M;
if the price is not observable at time t, then CDXₜ(T_{D},M) is the spread at which the difference between the put and call prices is smallest;
if there exists an option struck at CDXₜ(T_{D},M), then K_{*} equals CDXₜ(T_{D},M);
if there does not exist an option struck at CDXₜ(T_{D},M), then K_{*} is the first available strike below CDXₜ(T_{D},M);
v_{1,t} is a price value of a basis point at time t, adjusted for default risk, of the credit default swap index premium payments;
SWₜ^{r}(Kᵢ,T,T_{D};M) is a price at time t of a receiver option, struck at Kᵢ, expiring at T, and having an underlying credit default swap index derivative expiring at T_{D} with an underlying credit default swap index maturing at M;
SWₜ^{p}(Kᵢ,T,T_{D};M) is a price at time t of a payer option, struck at Kᵢ, expiring at T, and having an underlying credit default swap index derivative expiring at T_{D} with an underlying credit default swap index maturing at M; and
C-VI(t,T,T_{D},M) is the value of the credit volatility index at time t calculated based on options expiring at T on credit default swap index derivatives expiring at T_{D} with an underlying credit default swap index maturing at M.

18. The non-transitory computer readable storage medium of claims 13, 14, 15 or 16, wherein the credit volatility index is calculated at time t according to the equation:
$$C - {VI}^{bj} ( t , T , {T}_{D} , M ) ≡ {100}^{2} \times \sqrt{\frac{1}{( T - t )} [ \begin{matrix}\frac{2}{{v}_{1 , t}} [ \begin{matrix}{\sum }_{i : {K}_{i} < {K}_{*}} {SW}_{t}^{r} ( {K}_{i} , T , {T}_{D} ; M ) Δ {K}_{i} + \\ {\sum }_{i : {K}_{i} \geq {K}_{*}} {SW}_{t}^{p} ( {K}_{i} , T , {T}_{D} ; M ) Δ {K}_{i}\end{matrix} ] - \\ {( {CDX}_{t} ( {T}_{D} , M ) - {K}_{*} )}^{2}\end{matrix} ]}$$
wherein:
t denotes a time at which the credit volatility index is calculated;
T denotes a time of expiry of options on credit default swap index derivatives;
T_{D} denotes a time of maturity of credit default swap index derivatives underlying the options where T_{D}≧T;
M denotes a time of expiry of credits default swap indexes;
Z+1 denotes a total number of options used in the index calculation;
K₀ denotes the lowest strike of the Z+1 options;
Kᵢ denotes the i^{th} highest strike of the Z+1 options;
K_{Z} denotes the highest strike of the Z+1 options;
$$Δ {K}_{i} = \frac{1}{2} ( {K}_{i + 1} - {K}_{i - 1} )$$
for i≧1, and ΔK₀=(K₁−K₀), ΔK_{Z}=(K_{Z}−K_{Z-1});
if the price is observable at time t, then CDXₜ(T_{D},M) is a price at time t of a credit default swap index derivative underlying the put and call options, expiring at T_{D} with an underlying credit default swap index maturing at M;
if the price is not observable at time t, then CDXₜ(T_{D},M) is the spread at which the difference between the put and call prices is smallest;
if there exists an option struck at CDXₜ(T_{D},M), then K_{*} equals CDXₜ(T_{D},M);
if there does not exist an option struck at CDXₜ(T_{D},M), then K_{*} is the first available strike below CDXₜ(T_{D},M);
v_{1,t} is a price value of a basis point at time t, adjusted for default risk, of the credit default swap index premium payments;
SWₜ^{r}(Kᵢ,T,T_{D};M) is a price at time t of a receiver option, struck at Kᵢ, expiring at T, and having an underlying credit default swap index derivative expiring at T_{D} with an underlying credit default swap index maturing at M;
SWₜ^{p}(Kᵢ,T,T_{D};M) is a price at time t of a payer option, struck at Kᵢ, expiring at T, and having an underlying credit default swap index derivative expiring at T_{D} with an underlying credit default swap index maturing at M; and
C-VI^{bp}(t,T,T_{D},M) is the value of the credit volatility index at time t calculated based on options expiring at T on credit default swap index derivatives expiring at T_{D} with an underlying credit default swap index maturing at M.

19. The non-transitory computer readable storage medium of claim 11, wherein the at least one processor is further caused to:
create a standardized exchange-traded derivative instrument based on the credit volatility index; and
transmit data regarding the standardized exchange-traded derivative.

20. The non-transitory computer readable storage medium of claim 19, wherein transmitting data regarding the standardized exchange-traded derivative instrument includes transmitting data regarding one or more of a settlement price, a bid price, an offer price, or a trade price of the standardized exchange-traded derivative instrument.
